(19) United States
(12) Patent Application Publication
(10) Pub. No.: US 2023/0112909 A1
(43) Pub. Date: Apr. 13, 2023

(54) CYCLOHEXANOL-CAPPED COMPOUNDS AND THEIR USE AS PLASTICIZERS

(71) Applicant: BASF SE, Ludwigshafen am Rhein (DE)

(72) Inventors: Uwe STORZUM, Pasadena, TX (US); Samuel David TIMPA, Pasadena, TX (US); Boris BREITSCHEIDEL, Ludwigshafen am Rhein (DE)

(21) Appl. No.: 17/913,174

(22) PCT Filed: Mar. 15, 2021
(86) PCT No.: PCT/EP2021/056480

§ 371 Date: Sep. 21, 2022

Related U.S. Application Data
(60) Provisional application No. 62/994,334, filed on Mar. 25, 2020.

(30) Foreign Application Priority Data
Jun. 23, 2020 (EP) 20181524.8

(51) Int. Cl. C08L 27/06; C08G 63/199

(52) U.S. Cl. CPC C08L 27/06; C08G 63/199; C08L 2205/03

(57) ABSTRACT

Cyclohexanol-capped compounds and their use as plasticizers The presently claimed invention relates to a compound of formula (I) having cyclohexane end capping, (I). It further relates to a molding comprising said compound and its use as plasticizer. It also relates to the plasticizer composition comprising at least one compound of formula (I), as described herein.

### FIELD OF THE INVENTION

The presently claimed invention relates to cyclohexanol-capped compounds for the use as plasticizers for plastics.

### BACKGROUND OF THE INVENTION

With the ever-increasing demand for plastics, the strain on industrial production has been high. Several important changes in plastic production, such as addition of processing aids and plasticizers, have led to an increase in production efficiency.

Plasticizers, in particular, are critical additives that decrease the viscosity (or plasticity) of plastic such as polyvinyl chloride (PVC), thereby enhancing its flexibility. Herein, the plasticizers are expected to enmesh themselves between the polymer chains, thereby increasing the free volume and lowering the glass transition temperature. The plastics, thus, tend to become mouldable and easier to process.

An important additional criterion for plasticizer is its compatibility with the plastics. Plasticizers are known to exude out during the period of use, thereby leading to a loss of elastic properties of the plasticized products. Two important factors in this regard are: i) the ability of plasticizer to stay within a soft PVC without moving to the surface (compatibility) and ii) the movement of the plasticizer (or other components) from one matrix to another that is in physical contact (migration). The resistance towards bleeding/exudation is found to be particularly significant in case of applications, wherein contact with other plastics or oils is routine.

Esters have traditionally been dominant as plasticizers. Polyesters have been considered specialty plasticizers out of this group. Other than solid polyesters (fibers), the polymeric plasticizers are typically liquid with viscosities between ~500 and ~ 50 000 mPa*s at 20° C. However, in order to establish suitable compatibility with plastics such as PVC, a mixture of plasticizers has routinely been employed. EP 3250635 B1 discloses plasticizer compositions containing polymeric dicarboxylic acid esters and terephthalic acid dialkyl esters. The polyester plasticizer that is based on adipic acid, 1,2-propandiol and n-octanol alone was found to be ineffective. Herein, the addition of terephthalic acid dialkyl esters such as di(2-ethylhexyl) terephthalate was found to enhance the compatibility of the plasticizer with PVC.

Similarly, WO2016026835 A1 discloses plasticizer compositions containing polymeric dicarboxylic acid esters and 1,2-cyclohexanedicarboxylic acid esters. An alternative to the environmentally hazardous phthalate ester-based plasticizers is provided.

US 6,624,285 B2 relates to polyesters blocked with isomeric nonanols and their use as plasticizers. The nonanol-blocked plasticizers address the bleeding of plasticizers by evaporation or by migration to a secondary plastic with which it is in contact.

Low gelation temperature, low viscosity and high processability are particularly useful parameters for establishing the viability of industrial production of plasticizers. However, the above-mentioned chemical modifications to polyesters are often found to have detrimental effects in terms of those parameters.

Therefore, there is an unfulfilled need to establish plasticizers that are capable of enhancing processing, as evidenced by a low gelation temperature and low viscosity, while remaining compatible with a wide variety of plastics, including PVC.

### SUMMARY OF THE INVENTION

Surprisingly it has been found, that the end-capping of certain polyester compounds with cyclohexanol yields polymeric compounds that provide improved processing parameters such as gelation temperature and viscosity while being compatible with a wide array of different polymers.

Accordingly, one aspect of the presently claimed invention is directed to a compound of the formula (I),

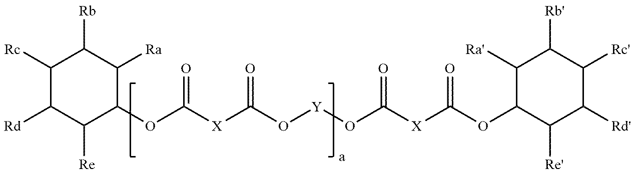

in which
X independently at each occurrence is selected from the group of unbranched or branched, unsubstituted or substituted C₄-C₈ alkylene, unbranched or branched, unsubstituted or substituted C₂-C₈ alkenylene, unsubstituted or substituted C₆-C₁₅ arylene, and unsubstituted or substituted C₆-C₁₅ cycloalkylene,
Y independently at each occurrence is selected from the group of unbranched or branched, unsubstituted or substituted C₄-C₁₂ alkylene and unbranched or branched, unsubstituted or substituted C₂-C₁₂ alkenylene,
a is an integer in the range from 1 to 100, and
Ra, Rb, Rc, Rd, Re, Ra′, Rb′, Rc′, Rd′, and Re′ independently at each occurrence are selected from the group of H, unbranched or branched, unsubstituted or substituted C₁-C₁₂ alkyl and unbranched or branched, and unsubstituted or substituted C₂-C₁₂ alkenyl.

In another aspect, the presently claimed invention is directed to a plasticizer composition comprising at least one compound of formula (I) as described herein.

In yet another aspect, the presently claimed invention is directed to a molding composition comprising: i) at least one polymer; and ii) the at least one compound of formula (I) as described herein or the plasticizer composition as described herein.

In an alternate aspect, the presently claimed invention is directed to the use of a compound of formula (I) as described herein or the plasticizer composition as described herein, as plasticizer for thermoplastic polymers and elastomers.

In yet another aspect, the presently claimed invention is directed to a use of a molding composition for producing moldings and foils.

### DETAILED DESCRIPTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘i’, ‘ii’, ‘iii’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well, i.e. a range of 10 to 99 implies that both 10 and 99 are included in the range. For the avoidance of doubt, applicant shall be entitled to any equivalents according to applicable law. Further, the value selectable within the range need not be only integers such as 12, 14, 95, 98, and so on, but also non-integral numbers such as 12.5, 14.2, 95.2, 98.5, and so on.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment but may refer to the same embodiment. Further, as used in the following, the terms “preferably”, “more preferably”, “even more preferably”, “most preferably” and “in particular” or similar terms are used in conjunction with optional features, without restricting alternative possibilities. Thus, features introduced by these terms are optional features and are not intended to restrict the scope of the claims in any way.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

As mentioned above, there exists a need for polymeric compounds that are capable of functioning as stable and compatible plasticizers, while displaying improved characteristics such as viscosity, gelation temperature. End capping with i-nonanol (as described in US 6,624,285) was found to be effective in improving stability of plasticizers. Herein, it was surprisingly identified that the end capping of polyester compounds with cyclohexanol and substituted cyclohexanol was found to display improved processability, in terms of reduced viscosity and gelation temperature. Additionally, the newly identified compounds were also found to be highly stable and resistant towards migration.

Accordingly, one aspect of the presently claimed invention is directed to a compound of the formula (I),

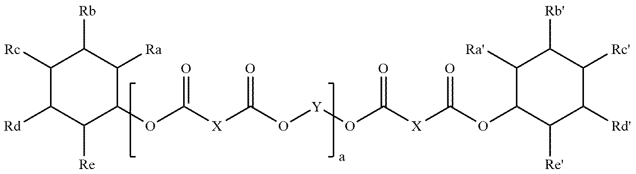

in which
X independently at each occurrence is selected from the group of unbranched or branched, unsubstituted or substituted C₄-C₈ alkylene, unbranched or branched, unsubstituted or substituted C₂-C₈ alkenylene, unsubstituted or substituted C₆-C₁₅ arylene, and unsubstituted or substituted C₆-C₁₅ cycloalkylene,
Y independently at each occurrence is selected from the group of unbranched or branched, unsubstituted or substituted C₄-C₁₂ alkylene and unbranched or branched, unsubstituted or substituted C₂-C₁₂ alkenylene,
a is an integer in the range from 1 to 100, and
Ra, Rb, Rc, Rd, Re, Ra′, Rb′, Rc′, Rd′, and Re′ independently at each occurrence are selected from the group of H, unbranched or branched, unsubstituted or substituted C₁-C₁₂ alkyl and unbranched or branched, and unsubstituted or substituted C₂-C₁₂ alkenyl .

As used herein, “branched” denotes a chain of atoms with one or more side chains attached to it. Branching occurs by the replacement of a substituent, e.g., a hydrogen atom, with a covalently bonded aliphatic moiety.

In connection with “alkylene”, the term “substituted” within the scope of the presently claimed invention is understood as meaning the substitution of hydrogen by 1, 2, 3, 4 or 5 substituents selected from the group consisting of F, Cl, Br, I, CN, NH₂, NH-C₁₋₆-alkyl, NH-C₁₋₆-alkylene-OH, N(C₁₋₆-alkyl)₂, N(C₁₋₆-alkylene-OH)₂, NO₂, SH, S-C₁₋₆-alkyl, S-benzyl, O-C₁₋₆-alkyl, O-C₁₋₆-alkylene-OH, ═O, O-benzyl, C(=O)C₁₋₆-alkyl, CO₂H, CO₂-C₁₋₆-alkyl, phenyl or benzyl. The substitution of hydrogen occurs either on different atoms or on the same atom, for example trisubstituted on the same carbon atom, as in the case of CF₃ or CH₂CF₃, or at different positions, as in the case of CH(Cl)—CH—CH—CHCl₂. Polysubstitution can be carried out with the same or with different substituents, such as, for example, in the case of CH(OH)—CH—CH—CHCl₂.

For the purposes of the presently claimed invention, the expression “C₄-C₁₂ alkylene” refers to divalent hydrocarbon radicals having 4 to 12 carbon atoms. The divalent hydrocarbon radicals may be unbranched or branched, substituted or unsubstituted. They include, for example, 1,3-butylene, 1,4-butylene, 2-methyl-1,3-propylene, 1,1-dimethyl-1,2-ethylene, 1,4-pentylene, 1,5-pentylene, 2-methyl-1,4-butylene, 2,2-dimethyl-1,3-propylene, 1,6-hexylene, 2-methyl-1,5-pentylene, 3-methyl-1,5-pentylene, 2,3-dimethyl-1,4-butylene, 1,7-heptylene, 2-methyl-1,6-hexylene, 3-methyl-1,6-hexylene, 2-ethyl-1,5-pentylene, 3-ethyl-1,5-pentylene, 2,3-dimethyl-1,5-pentylene, 2,4-dimethyl-1,5-pentylene, 1,8-octylene, 2-methyl-1,7-heptylene, 3-methyl-1,7-heptylene, 4-methyl-1,7-heptylene, 2-ethyl-1,6-hexylene, 3-ethyl-1,6-hexylene, 2,3-dimethyl-1,6-hexylene, 2,4-dimethyl-1,6-hexylene, 1,9-nonylene, 2-methyl-1,8-octylene, 3-methyl-1,8-octylene, 4-methyl-1,8-octylene, 2-ethyl-1,7-heptylene, 3-ethyl-1,7-heptylene, 1,10-decylene, 2-methyl-1,9-nonylene, 3-methyl-1,9-nonylene, 4-methyl-1,9-nonylene, 5-methyl-1,9-nonylene, 1,11-undecylene, 2-methyl-1,10-decylene, 3-methyl-1,10-decylene, 5-methyl-1,10-decylene, 1,12-dodecylene, and the like. Preferably “C₄-C₁₂ alkylene” comprises branched or unbranched C₄-C₈ alkylene groups, more preferably branched or unbranched C₄-C₆-alkylene groups, more particularly 2,2-dimethyl-1,3-propylene, and 1,4-butylene.

The expression “C₄-C₁₂ alkylene” also includes within its definition the expression “C₄-C₈ alkylene”, “C₄-C₆ alkylene”, and “C₄-C₅ alkylene”.

For the purposes of the presently claimed invention, the expression “C₄-C₈ alkylene” refers to divalent hydrocarbon radicals having 4 to 8 carbon atoms. The divalent hydrocarbon radicals may be unbranched or branched, substituted or unsubstituted. They include, for example, 1,3-butylene, 1,4-butylene, 2-methyl-1,3-propylene, 1,1-dimethyl-1,2-ethylene, 1,4-pentylene, 1,5-pentylene, 2-methyl-1,4-butylene, 2,2-dimethyl-1,3-propylene, 1,6-hexylene, 2-methyl-1,5-pentylene, 3-methyl-1,5-pentylene, 2,3-dimethyl-1,4-butylene, 1,7-heptylene, 2-methyl-1,6-hexylene, 3-methyl-1,6-hexylene, 2-ethyl-1,5-pentylene, 3-ethyl-1,5-pentylene, 2,3-dimethyl-1,5-pentylene, 2,4-dimethyl-1,5-pentylene, 1,8-octylene, 2-methyl-1,7-heptylene, 3-methyl-1,7-heptylene, 4-methyl-1,7-heptylene, 2-ethyl-1,6-hexylene, 3-ethyl-1,6-hexylene, 2,3-dimethyl-1,6-hexylene, 2,4-dimethyl-1,6-hexylene, and the like. Preferably “C₄-C₈ alkylene” comprises branched or unbranched C₄-C₆-alkylene groups, more particularly 2,2-dimethyl-1,3-propylene, and 1,4-butylene.

For the purposes of the presently claimed invention, the expression “C₂-C₁₂ alkenylene” relates to divalent hydrocarbon radicals having 2 to 12 carbon atoms, with the main chain having at least one double bond. These include, for example, ethenylene, propenylene, 1-, 2-butenylene, -, 2-pentenylene, 1-, 2-, 3-octenylene, and the like. With particular preference the “C₂-C₁₂ alkenylene” comprises branched and unbranched C₂-C₈ alkenylene groups having one double bond, more particularly branched and unbranched C₂-C₆ alkenylene groups having one double bond. The expression “C₂-C₁₂ alkenylene” also includes within its definition the expressions “C₂-C₈ alkenylene”, “C₂-C₆ alkenylene” and “C₃-C₅ alkenylene”.

For the purposes of the presently claimed invention, the unsubstituted linear C₂-C₁₂ alkenylene is preferably selected from the group consisting of 1-methylethenylene, 1-methylpropenylene, 2-methylpropenylene, 1-methyl-1-butenylene, 1-methyl-2-butenylene, 1-, 2-, 3-hexenylene, 1-methyl-1-pentenylene, 1-methyl-2-pentenylene, 1-methyl-3-pentenylene, 1,4-dimethyl-1-butenylene, 1,4-dimethyl-2-butenylene, 1-, 2-, 3-heptenylene, and the like.

The double bonds in the C₂-C₁₂ alkenylene groups may independently of one another be present in the E- or in Z-configuration or as a mixture of both configurations.

In a preferred embodiment, the substituted, linear or branched C₂-C₁₂ alkenylene refers to a branched or linear saturated hydrocarbon group having C₂-C₁₂ carbon atoms substituted with functional groups selected from the group consisting of hydroxy, alkoxy, C(═O)—R₄, CN, C(═O)—OR₄, C(═O)—NR₅, NR₅ and SR₄, wherein R₄ and R₅ are independently selected from the group consisting of hydrogen, substituted or unsubstituted, linear or branched C₁-C₁₂ alkyl, substituted or unsubstituted, linear or branched C₂-C₁₂ alkenyl, substituted or unsubstituted C₅-C₁₂ cycloalkyl, substituted or unsubstituted C₅-C₁₂ cycloalkenyl, substituted or unsubstituted C₆-C₁₂ aryl and substituted or unsubstituted C₇-C₁₂ arylalkyl.

For the purposes of the presently claimed invention, the term “alkyl” used herein, refers to an acylic saturated aliphatic group, including linear or branched alkyl saturated hydrocarbon radicals, denoted by a general formula CₙH₂ₙ₊₁ and wherein n is the number of carbon atoms such as 1, 2, 3, 4, etc.

For the purposes of the presently claimed invention, the unsubstituted linear C₁-C₁₂ alkyl is preferably selected from the group consisting of methyl, ethyl, propyl, butyl, pentyl, hexyl, heptyl, octyl, nonyl, decyl, undecyl and dodecyl; more preferably selected from the group consisting of hexyl, heptyl, octyl, nonyl, decyl, undecyl, and dodecyl; and in particular selected from the group consisting of methyl, ethyl, propyl, butyl, pentyl, hexyl, heptyl, octyl, nonyl and decyl.

In a preferred embodiment, the unsubstituted branched C₁-C₁₂ alkyl is preferably selected from the group consisting of isopropyl, iso-butyl, neo-pentyl, 2-ethyl-hexyl, 2-propyl-heptyl, 2-butyl-octyl, 2-pentyl-nonyl, 2-hexyl-decyl, iso-hexyl, iso-heptyl, iso-octyl, iso-nonyl, isodecyl and iso-dodecyl, more preferably selected from the group consisting of 2-ethyl-hexyl, 2-propyl-heptyl, 2-butyl-octyl, 2-pentyl-nonyl, 2-hexyl-decyl, iso-hexyl, iso-heptyl, iso-octyl, iso-nonyl, iso-decyl and iso-dodecyl.

In a preferred embodiment, the substituted, linear or branched C₁-C₁₂ alkyl refers to a branched or linear saturated hydrocarbon group having C₁-C₁₂ carbon atoms substituted with functional groups selected from the group consisting of hydroxy, alkoxy, C(═O)—R₄, CN, C(═O)—OR₄, C(═O)—NR₅, NR₅ and SR₄, wherein R₄ and R₅ are independently selected from the group consisting of hydrogen, substituted or unsubstituted, linear or branched C₁-C₁₂ alkyl, substituted or unsubstituted, linear or branched C₂-C₁₂ alkenyl, substituted or unsubstituted C₅-C₁₂ cycloalkyl, substituted or unsubstituted C₅-C₁₂ cycloalkenyl, substituted or unsubstituted C₆-C₁₂ aryl and substituted or unsubstituted C₇-C₁₂ arylalkyl.

In a preferred embodiment, the substituted, linear or branched C₁-C₁₂ alkyl refers to a branched or linear saturated hydrocarbon group having C₁-C₁₂ carbon atoms substituted with functional groups selected from the group consisting of hydroxy, alkoxy, C(═O)—R₄, CN, C(═O)—OR₄, C(═O)—NR₅, NR₅ and SR₄, preferably selected from the group consisting of 1-hydroxy methyl, 1-methoxy methyl, 1-hydroxy ethyl, 1-hydroxy propyl, 1-hydroxy butyl, 1-hydroxy pentyl, 1-hydroxy hexyl, 1-hydroxy heptyl, 1-hydroxy octyl, 1-hydroxy nonyl, 1-hydroxy decyl, 1-hydroxy undecyl, 1-hydroxy dodecyl, 1-methoxy methyl, 1-methoxy ethyl, 1-methoxy propyl, 1-methoxy butyl, 1-methoxy pentyl, 1-methoxy hexyl, 1-methoxy heptyl, 1-methoxy octyl, 1-methoxy nonyl, 1-methoxy decyl, 1-methoxy undecyl, 1-methoxy dodecyl, 2-methoxy propyl, 2-methoxy butyl, 2-methoxy pentyl, 2-methoxy hexyl, 2-methoxy heptyl, 2-methoxy octyl, 2-methoxy nonyl, 2-methoxy decyl, 2-methoxy undecyl, 2-methoxy dodecyl, 1-acetoxy methyl, 1-acetoxy ethyl, 1-acetoxy propyl, 1-acetoxy butyl, 1-acetoxy pentyl, 1-acetoxy hexyl, 1-acetoxy heptyl, 1-acetoxy octyl, 1-acetoxy nonyl, 1-acetoxy decyl, 1-acetoxy undecyl, 1-acetoxy dodecyl, 1-cyano methyl, 1-cyano ethyl, 1-cyano propyl, 1-cyano butyl, 1-cyano pentyl, 1-cyano hexyl, 1-cyano heptyl, 1-cyano octyl, 1-cyano nonyl, 1-cyano decyl, 1-cyano undecyl, 1-cyano dodecyl, 2-cyano propyl, 2-cyano butyl, 2-cyano pentyl, 2-cyano hexyl, 2-cyano heptyl, 2-cyano octyl, 2-cyano nonyl, 2-cyano decyl, 2-cyano undecyl, 2-cyano dodecyl, 1-thioyl methyl, 1-thioyl ethyl, 1-thioyl propyl, 1-thioyl butyl, 1-thioyl pentyl, 1-thioyl hexyl, 1-thioyl heptyl, 1-thioyl octyl, 1-thioyl nonyl, 1-thionyl decyl, 1-thioyl undecyl and 1-thioyl dodecyl.

For the purposes of the presently claimed invention, the expression “alkenyl” denotes unsubstituted, linear C₂-C₁₂ alkenyl which is preferably selected from the group consisting of 1-propenyl, 1-butenyl, 1-pentenyl, 1-hexenyl,2-hexenyl, 1-heptenyl, 2-heptenyl, 1-octenyl, 2-octenyl, 1-nonenyl, 2-nonenyl,1-decenyl, 2-decenyl, 1-undecenyl, 2-undecenyl, 1-dodecenyl, 2-dodecenyl, more preferably selected from 1-hexenyl, 2-hexenyl, 1-heptenyl, 2-heptenyl, 1-octenyl, 2-octenyl, 1-nonenyl, 2-nonenyl,1-decenyl, 2-decenyl, 1-undecenyl, 2-undecenyl, 1-dodecenyl, 2-dodecenyl.

In a preferred embodiment, the unsubstituted branched C₂-C₁₂ alkenyl is selected from the group consisting of isopropenyl, iso-butenyl, neo-pentenyl, 2-ethyl-hexenyl, 2-propyl-heptenyl, 2-butyl-octenyl, 2-pentyl-nonenyl, 2-hexyl-decenyl, iso-hexenyl, iso-heptenyl, iso-octenyl, iso-nonenyl, iso-decenyl, iso-dodecenyl, 1,4-hexadienyl, 1,3-hexadienyl, 2,5-hexadienyl, 3,5-hexadienyl, 2,4-hexadienyl, 1,3,5-hexatrienyl, 1,3,6-heptatrienyl, 1,4,7-octatrienyl or2-methyl-1,3,5hexatrienyl, 1,3,5,7-octatetraenyl, 1,3,5,8-nonatetraenyl, 1,4,7,10-undecatetraenyl, 2-ethyl-1,3,6,8-nonatetraenyl, 2-ethenyl-1,3,5,8-nonatetraenyl, 1,3,5,7,9-decapentaenyl, 1,4,6,8,10-undecapentaenyl and 1,4,6,9,11 -dodecapentaenyl.

In a preferred embodiment, the substituted, linear or branched C₂-C₁₂ alkenyl refers to a branched or a linear unsaturated hydrocarbon group having C₂-C₁₂ carbon atoms substituted with functional groups selected from, hydroxy, alkoxy, C(═O)—R₄, CN and SR₄; wherein R₄ is hydrogen, substituted or unsubstituted, linear or branched C₁-C₁₂ alkyl, substituted or unsubstituted, linear or branched C₂-C₁₂ alkenyl, substituted or unsubstituted C₅-C₁₂ cycloalkyl , substituted or unsubstituted C₅-C₁₂ cycloalkenyl, substituted or unsubstituted C₆-C₁₂ aryl, substituted or unsubstituted C₇-C₁₂ arylalkyl.

In a preferred embodiment the substituted, linear or branched C₂-C₁₂ alkenyl refers to a branched or a linear unsaturated hydrocarbon group having C₂-C₁₂ carbon atoms substituted with functional groups selected from hydroxy, alkoxy, C(═O)—R₄, CN and SR₄; preferably selected from the group consisting of 2-hydroxy propenyl, 3-hydroxy butenyl, 3-hydroxy pentenyl, 5-hydroxy hexenyl, 7-hydroxy heptenyl, 3-hydroxy octenyl, 5-hydroxy nonenyl, decyl, 11-hydroxy undecenyl, 9-hydroxy dodecenyl, 1-methoxy ethenyl, 2-methoxy propenyl, 4-methoxy butenyl, 3-methoxy pentenyl, 5-methoxy hexenyl, 2-methoxy heptenyl, 5-methoxy octenyl, 3-methoxy nonenyl, 6-methoxy undecenyl, 1-methoxy dodec-2-enyl, 2-methoxy prop-1-enyl, 2-methoxy but-1-enyl, 2-methoxy pent-4-enyl, 2-methoxy hex-2-enyl, 2-methoxy hept-3-enyl, 2-methoxy oct-7-enyl, 2-methoxy non-5-enyl, 2-methoxy undec-10-enyl, 2-methoxy dodec-4-enyl, 1-acetoxy ethenyl, 1-acetoxy prop-1-enyl, 1-acetoxy but-2-enyl, 1-acetoxy pent-4-enyl, 1-acetoxy hex-2-enyl, 1-acetoxy hept-1-enyl, 1-acetoxy oct-7-enyl, 1-acetoxy non-2-enyl, 5-acetoxy dec-3-enyl, 1-acetoxy undec-10-enyl, 1-acetoxy dodec-2-enyl, 1-cyano eth-1-enyl, 1-cyano prop-2-enyl, 1-cyano but-2-enyl, 1-cyano pent-3-enyl, 1-cyano hex-5-enyl, 1-cyano hept-6-enyl, 1-cyano oct-2-enyl, 1-cyano non-3-enyl, 11-cyano undec-2-enyl, 10-cyano dodec-2-enyl, 2-cyano prop-2-enyl, 2-cyano but-1-enyl, 2-cyano pent-1-enyl, 2-cyano hex-3-enyl, 2-cyano hept-6-enyl, 2-cyano oct-1-enyl, 2-cyano non-8-enyl, 2-cyano undec-10-enyl, 2-cyano dodec-1-enyl, 1-thionyl eth-1-enyl, 1-thionyl prop-2-enyl, 1-thionyl but-2-enyl, 1-thionyl pent-4-enyl, 1-thionyl hex-2-enyl, 1-thionyl hept-5-enyl, 1-thionyl oct-3-enyl, 1-thionyl non-5-enyl, 1-thionyl undec-10-enyl and 1-thionyl dodec-11-enyl.

For the purposes of the presently claimed invention, the expression “C₆-C₁₅ arylene” relates to mono-or polycyclic, optionally substituted aromatic radicals having 6 to 15 carbon atoms. The “C₆-C₁₅ arylene” preferably comprises substituted or unsubstituted C₆-C₈ arylene groups. Unsubstituted arylene include, for example, 1,2-phenylene, 1,3-phenylene and 1,4-phenylene. The substituted arylene include, for example, 1-methyl-2,3-phenylene, 1-methyl-2,4-phenylene, 1-ethyl-2,3-phenylene, 1-ethyl-2,4-phenylene, and the like. The expression “C₆-C₁₅ arylene” also includes within its definition the expressions “C₆-C₁₀ arylene” and “C₆-C₈ arylene”.

For the purposes of the presently claimed invention, the expression “C₆-C₁₅ cycloalkylene” relates to mono- or polycyclic, optionally substituted radicals having 2 to 15 carbon atoms. The “C₂-C₁₅ cycloalkylene” preferably comprises C₂-C₈ cycloalkylene groups. The unsubstituted C₂-C₁₅ cycloalkylene include, for example, 1,2-cyclohexylene, 1,3-cyclohexylene, 1,4-cyclohexylene. The substituted C₂-C₁₅ cycloalkylene include, for example, 1-methyl-2,3-cyclohexylene, 1-methyl-2,4-cyclohexylene, 1-ethyl-2,3-cyclohexylene, 1-ethyl-2,4-cyclohexylene, and the like. With particular preference the “C₂-C₁₅ cycloalkylene” comprises substituted and unsubstituted C₆-C₁₀ cycloalkylene groups having one double bond, more particularly substituted and unsubstituted C₆-C₈ cycloalkylene groups having one double bond.

The expression “C₆-C₁₅ cycloalkylene ” also includes within its definition the expressions “C₆-C₁₀ cycloalkylene ” and “C₆-C₈ cycloalkylene”.

In a preferred embodiment of the presently claimed invention, X, independently at each occurrence, is preferably an unbranched or branched C₄-C₈ alkylene group, more preferably an unbranched or branched C₄-C₆ alkylene group. More particularly, X, independently at each occurrence, is an unbranched C₄-C₅ alkylene group, especially 1,4-butylene.

In a preferred embodiment of the presently claimed invention, Y independently at each occurrence is preferably an unbranched or branched C₄-C₁₂ alkylene group, more preferably an unbranched or branched C₄-C₁₀ alkylene group. More particularly, Y is a branched or unbranched C₄-C₈ alkylene group, especially C₄-C₆ alkylene group, and more particularly, C₄-C₅ alkylene group and1,4-butylene, or 2,2-dimethyl-1,3-propylene.

In a preferred embodiment of the presently claimed invention, the groups X have the same definition.

In another preferred embodiment of the presently claimed invention, if the compounds (I) contain more than one group Y, then in a first preferred variant they have the same definition.

In yet another preferred embodiment of the presently claimed invention, if the compounds (I) contain more than one group Y, then in a second variant they have different definitions.

In a preferred embodiment of the presently claimed invention, the groups X present in the compound (I) have the same definition, with the compounds (I) comprising more than one group Y which have different definitions.

In a preferred embodiment of the presently claimed invention, X and Y have the same definition.

In a more preferred embodiment of the presently claimed invention, X independently at each occurrence is unbranched, unsubstituted C₄-C₈ alkylene and Y independently at each occurrence is unbranched, unsubstituted C₄-C₁₂ alkylene. Preferably, X independently at each occurrence is unbranched, unsubstituted C₅-C₇ alkylene and Y independently at each occurrence is unbranched, unsubstituted C₅-C₁₁ alkylene. Preferably, X independently at each occurrence is unbranched, unsubstituted C₄-C₆ alkylene and Y independently at each occurrence is unbranched, unsubstituted C₄-C₁₀ alkylene.

In yet another preferred embodiment of the presently claimed invention, X independently at each occurrence is unsubstituted C₆-C₁₀ arylene and Y independently at each occurrence is unbranched, unsubstituted C₄-C₁₀ alkylene.

In yet another preferred embodiment of the presently claimed invention, X independently at each occurrence is unsubstituted C₆-C₈ arylene group and Y independently at each occurrence is unbranched, unsubstituted C₄-C₈ alkylene.

In a preferred embodiment of the presently claimed invention, Ra, Rb, Rc, Rd, Re, Ra′, Rb′, Rc′, Rd′, and Re′ are independently selected from the group of H, unsubstituted or substituted C₁-C₈ alkyl, and unsubstituted or substituted C₂-C₈ alkenyl.

In a preferred embodiment of the presently claimed invention, Ra, Rb, Rc, Rd, Re, Ra′, Rb′, Rc′, Rd′, and Re′ are independently selected from the group of H and unsubstituted or substituted C₁-C₈ alkyl.

In a more preferred embodiment of the presently claimed invention, Ra, Rb, Rc, Rd, Re, Ra′, Rb′, Rc′, Rd′, and Re′ are independently selected from the group of H and unsubstituted or substituted C₂-C₅ alkyl.

In a preferred embodiment of the presently claimed invention, Ra, Rb, Rc, Rd, Re, Ra′, Rb′, Rc′, Rd′, and Re′ are independently selected from the group of H and unsubstituted or substituted C₁-C₈ alkenyl.

In a more preferred embodiment of the presently claimed invention, Ra, Rb, Rc, Rd, Re, Ra′, Rb′, Rc′, Rd′, and Re′ are independently selected from the group of H and unsubstituted or substituted C₂-C₅ alkenyl.

In a most preferred embodiment of the presently claimed invention, Ra, Rb, Rc, Rd, Re, Ra′, Rb′, Rc′, Rd′, and Re′ are H.

In a preferred embodiment of the presently claimed invention, a is in the range from 1 to 40.

In a more preferred embodiment of the presently claimed invention, a is in the range from 1 to 20.

In an even more preferred embodiment of the presently claimed invention, a is in the range from 1 to 12.

On account of their polymeric nature, the compounds of the formula (I) used in the plasticizer compositions of the presently claimed invention are not unitary compounds but are instead mixtures of different compounds. On the one hand, the compounds (I) have different chain lengths, and are characterized accordingly by an average molar mass. On the other hand, the groups Ra, Rb, Rc, Rd, Re, Ra′, Rb′, Rc′, Rd′, and Re′, and also the groups X and Y present in the repeating units, may have different definitions.

In a preferred embodiment of the presently claimed invention, the compound of formula (I) has a number average molecular weight (Mn) in the range from 300 to 15 000 g/mol, preferably in the range from 700 to 12 000 g/mol, more preferably in the range from 500 to 10 000 g/mol, and even more preferably 1000 to 7000 g/mol. Mn was determined according to ASTM D3016.

In a preferred embodiment of the presently claimed invention, the compound of formula (I) has a density at 20° C. according to DIN 51757 in the range from 1.000 to 1.200 g/cm³, preferably in the range from 1.010 to 1.170 g/cm³, more preferably in the range from 1.020 to 1.150 g/cm³.

In a preferred embodiment of the presently claimed invention, the compound of formula (I) has a viscosity at 20° C. according to ASTM D445 in the range from 300 to 15000 mPa.s, preferably in the range from 500 to 10000 mPa.s, more preferably in the range from 500 to 3000 mPa.s.

In a preferred embodiment of the presently claimed invention, the compound of formula (I) has a gelation temperature in the range from 110 to 140° C., preferably in the range from 110 to 138° C., more preferably in the range from 112 to 133° C. The gelation temperature was measured using Discovery Hybrid Rheometer- Viscometer.

### Plasticizer Composition

Another aspect of the presently claimed invention is directed to a plasticizer composition comprising at least one compound of formula (I) as described herein.

In a preferred embodiment of the presently claimed invention, the plasticizer composition as described herein, comprises at least one compound of the formula (II),

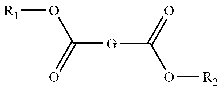

wherein
R₁ and R₂ independently of one another are unbranched or branched, unsubstituted or substituted C₄-C₁₂ alkyl, and
G is selected from the group of unbranched or branched, unsubstituted or substituted C₂-C₈ alkylene; unsubstituted or substituted phenylene; and unsubstituted or substituted cylcohexylene.

The embodiments in relation to compound of formula (I) as mentioned hereinabove are to be considered relevant in relation to the plasticizer composition of the presently claimed invention.

In a preferred embodiment of the presently claimed invention, R¹ and R², independently of one another, are preferably n-octyl, n-nonyl, isononyl, 2-ethylhexyl, isodecyl, 2-propylheptyl, n-undecyl or isoundecyl.

In a more preferred embodiment of the presently claimed invention, R¹ and R² have the same definition.

In another preferred embodiment of the presently claimed invention, R¹ and R² are both C₇ -C₁₂ alkyl, in particular both 2-ethylhexyl, both isononyl, or both 2-propylheptyl.

In a preferred embodiment of the presently claimed invention, G is selected from the group of unbranched or branched, unsubstituted or substituted C₂-C₆ alkylene; unsubstituted phenylene; and unsubstituted cyclohexylene.

In a more preferred embodiment of the presently claimed invention, G is selected from the group of unbranched or branched, unsubstituted or substituted C₃-C₅ alkylene; unsubstituted phenylene; and unsubstituted cyclohexylene.

In a more preferred embodiment of the presently claimed invention, G is selected from the group of unbranched or branched, unsubstituted or substituted C₃-C₅ alkylene; unsubstituted phenylene; and unsubstituted cyclohexylene.

In another preferred embodiment of the presently claimed invention, G is selected from the group of unsubstituted phenylene; and unsubstituted cyclohexylene.

In a more preferred embodiment of the presently claimed invention, G is selected from unbranched, unsubstituted C₂-C₆ alkylene.

In a more preferred embodiment of the presently claimed invention, G is unsubstituted phenylene.

In a more preferred embodiment of the presently claimed invention, G is unsubstituted cyclohexylene.

In yet another preferred embodiment of the presently claimed invention, G is selected from the group of 1,2-phenylene, 1,3-phenylene, 1,4-phenylene, 1,2-cyclohexylene, 1,3-cyclohexylene, and 1,4-cyclohexylene.

In a more preferred embodiment of the presently claimed invention, G is selected from the group of 1,2-phenylene, 1,4-phenylene, 1,2-cyclohexylene, and 1,4-cyclohexylene.

In an even more preferred embodiment of the presently claimed invention, the compound of formula (II) is selected from di(2-ethylhexyl) terephthalate, di(2-ethylhexyl) cyclohexane-1,2-dicarboxylate, dihexylcyclohexane-1,2-dicarboxylate, di(2-ethylhexyl) cyclohexane-1,4-dicarboxylate, and dihexylcyclohexane-1,4-dicarboxylate.

In an even more preferred embodiment of the presently claimed invention, the compound of formula (II) is di(2-ethylhexyl) terephthalate.

In a more preferred embodiment of the presently claimed invention, compounds of the general formula (I) are preferred, wherein
X is independently at each occurrence unbranched or branched C₂-C₆ alkylene,
Y is independently at each occurrence unbranched or branched C₂-C₅ alkylene,
a is an integer in the range from 5 to 40,
Ra, Rb, Rc, Rd, Re, Ra′, Rb′, Rc′, Rd′, and Re′ are H.

In a more preferred embodiment of the presently claimed invention, compounds of the general formula (II) are preferred, wherein R¹ and R² are independently of one another C₈-C₁₁ alkyl, and G is selected from the group of unbranched or branched, unsubstituted or substituted C₃-C₅ alkylene; unsubstituted phenylene; and unsubstituted cyclohexylene.

In a preferred embodiment of the presently claimed invention, the plasticizer composition further comprises a third compound, which is different from the compounds (I) and (II), and which is selected from the group of trimellitic trialkyl esters, benzoic alkyl esters, dibenzoic esters of glycols, hydroxybenzoic esters, esters of saturated monocarboxylic acids, esters of unsaturated monocarboxylic acids, amides and esters of aromatic sulfonic acids, alkylsulfonic esters, glycerol esters, isosorbide esters, phosphoric esters, citric triesters, alkylpyrrolidone derivatives, 2,5-furandicarboxylic esters, 2,5-tetrahydrofurandicarboxylic esters, epoxidized vegetable oils, epoxidized fatty acid monoalkyl esters, fatty acid esters of pentaerythritol, and polyesters of aliphatic and/or aromatic polycarboxylic acids with at least dihydric alcohols, other than compounds of formula (I).

Suitable polyesters of aliphatic and/or aromatic polycarboxylic acids with at least dihydric alcohols include a polyester having the viscosity in the range of 400 to 1200 mPa.s, more preferably the polyesters may include of polyester polyols of adipic acid.

Suitable trimellitic acid trialkyl esters preferably have, independently of one another, in each case 4 to 13 C atoms, more particularly 7 to 11 C atoms, in the alkyl chains. Suitable benzoic acid alkyl esters preferably have, independently of one another, in each case 7 to 13 C atoms, more particularly 9 to 13 C atoms, in the alkyl chains. Suitable benzoic acid alkyl esters are, for example, isononyl benzoate, isodecyl benzoate, or 2-propylheptyl benzoate. Suitable dibenzoic esters of glycols are diethylene glycol dibenzoate and dibutylene glycol dibenzoate. Suitable esters of saturated monocarboxylic acids are, for example, esters of acetic acid, butyric acid, valeric acid or lactic acid. Suitable esters of unsaturated monocarboxylic acids are, for example, esters of acrylic acid. Suitable alkylsulfonic esters preferably have an alkyl radical with 8 to 22 C atoms. They include, for example, phenyl or cresyl ester of pentadecylsulfonic acid. Suitable isosorbide esters are isosorbide diesters, which are preferably esterified with C₈-C₁₃ carboxylic acids. Suitable phosphoric esters are tri-2-ethylhexyl phosphate, trioctyl phosphate, triphenyl phosphate, isodecyl diphenyl phosphate, bis(2-ethylhexyl) phenyl phosphate, and 2-ethylhexyl diphenyl phosphate. In the citric triesters, the OH group may be present in free or carboxylated form, preferably in acetylated form. The alkyl radicals of the acetylated citric triesters preferably independently of one another have 4 to 8 C atoms, more particularly 6 to 8 C atoms. Alkylpyrrolidone derivatives having alkyl radicals of 4 to 18 C atoms are suitable. Suitable 2,5-furandicarboxylic acid dialkyl esters have, independently of one another, in each case 7 to 13 C atoms, preferably 8 to 12 C atoms, in the alkyl chains. Suitable 2,5-tetrahydrofurandicarboxylic acid dialkyl esters have, independently of one another, in each case 7 to 13 C atoms, preferably 8 to 12 C atoms, in the alkyl chains. A suitable epoxidized vegetable oil is, for example, epoxidized soybean oil, available, for example, from Galata-Chemicals, Lampertheim, Germany. Epoxidized fatty acid monoalkyl esters, available, for example, under the trade name reFlex™ from PolyOne, USA are also suitable.

In a preferred embodiment of the presently claimed invention, the plasticizer composition comprises no further plasticizers different from the compounds (I) and (II). The combination of compounds of formula (I) and formula (II) are noted to induce complementary beneficial effect in terms of the viscosity and processability (in particular gelation temperature). Further, the combination of the two compounds helps tune properties such that an enhanced compatibility with a wide range of polymers can be achieved.

In a preferred embodiment of the presently claimed invention, the plasticizer composition comprises compound of the formula (I) is present in an amount in the range of 10 to 99.5 wt.%, more preferably in an amount in the range of 20 to 99.5 wt.%, and even more preferably in an amount in the range of 40 to 99 wt.%, based on the total amount of the compounds (I) and (II) in the plasticizer composition.

In a preferred embodiment of the presently claimed invention, the plasticizer composition comprises compound of the formula (II) is present in an amount in the range of 1 to 90 wt.%, more preferably in an amount in the range of 2 to 70 wt.%, and even more preferably in an amount in the range of 3 to 60 wt.%, based on the total amount of the compounds (I) and (II) in the plasticizer composition.

In a preferred embodiment of the presently claimed invention, the plasticizer composition has a weight ratio of the at least one compound of formula (II) to the at least one compound of formula (I) in the range from 1 : 100 to 10 : 1, more preferably in the range from 1:50 to 3:1 and even more preferably in the range from 1:35 to 2:1.

### Molding Compositions

Yet another aspect of the presently claimed invention is directed to a molding composition comprising: i) at least one polymer; and ii) the at least one compound of formula (I) as described herein or the plasticizer composition comprising the compound of formula (I) as described herein.

Another preferred embodiment of the presently claimed invention is directed to a molding composition comprising: i) at least one polymer; and the plasticizer composition comprising: a) the at least one compound of formula (I) and b) at least one compound of formula (II), as described herein.

The embodiments in relation to the compound of formula (I) as mentioned hereinabove are to be considered relevant in relation to the molding composition of the presently claimed invention.

The embodiments in relation to the plasticizer composition comprising the compound of formula (I) as mentioned hereinabove are to be considered relevant in relation to the molding composition of the presently claimed invention.

Within the context of the presently claimed invention, the term “migration” refers to the mass transfer of plasticizer compound from a first plastic to a secondary plastic that is brought in contact with the first plastic. Said migration is noted to be detrimental to the characteristics of the first plastic, leading to corrosion and a proportional loss in its elasticity and mechanical integrity, and also corrosamong others. The molding composition of the presently claimed invention comprising the compound of formula (I) as described herein, or the plasticizer composition comprising the compound of formula (I) as described herein, is noted to have negligible migration, even when contacted with plastics.

Within the context of the presently claimed invention, the term “compatibility” as described herein, refers to the ability of the plasticizer to resist loss from a first plastic, via evaporation, exudation, extraction into fat or oil, or migration to a second plastic. The molding composition of the presently claimed invention comprising the compound of formula (I) or the plasticizer composition comprising compound of formula (I) is noted to have high compatibility.

In a preferred embodiment of the presently claimed invention, the at least one polymer of the molding composition is a thermoplastic polymer selected from the group of
homopolymers or copolymers comprising in copolymerized form at least one monomer selected from C₂-C₁₀ monoolefins, 1,3-butadiene, 2-chloro-1,3-butadiene, vinyl alcohol and its C₂-C₁₀ alkyl esters, vinyl chloride, vinylidene chloride, vinylidene fluoride, tetrafluoroethylene, glycidyl acrylate, glycidyl methacrylate, acrylates and methacrylates of C₁-C₁₀ alcohols, vinylaromatics, (meth)acrylonitrile, maleic anhydride, and α-ethylenically unsaturated monocarboxylic and dicarboxylic acids,
homopolymers and copolymers of vinyl acetals,
polyvinyl esters,
polycarbonates,
polyesters,
polyethers,
polyetherketones,
polyurethanes,
polysulfides,
polysulfones,
polyethersulfones,
cellulose alkyl esters,
and mixtures thereof.

In a preferred embodiment of the presently claimed invention, the thermoplastic polymer in the molding composition comprises polyacrylates with identical or different alcohol residues from the group of the C₄-C₈ alcohols, particularly those of butanol, hexanol, octanol, and 2 ethylhexanol.

In a preferred embodiment of the presently claimed invention, the thermoplastic polymer in the molding composition comprises a thermoplastic polymer selected from the group consisting of polymethyl methacrylate (PMMA), methyl methacrylate-butyl acrylate copolymers, acrylonitrile-butadiene-styrene copolymers (ABS), ethylene-propylene copolymers, ethylene-propylene-diene copolymers (EPDM), polystyrene (PS), styrene-acrylonitrile copolymers (SAN), acrylonitrile-styrene-acrylate (ASA), styrene-butadiene-methyl methacrylate copolymers (SBMMA), styrene-maleic anhydride copolymers, styrene-methacrylic acid copolymers (SMA), polyoxymethylene (POM), polyvinyl alcohol (PVAL), polyvinyl acetate (PVA), polyvinyl butyral (PVB), ethylene vinyl acetate (EVA), polycaprolactone (PCL), polyhydroxybutyric acid (PHB), polyhydroxyvaleric acid (PHV), polylactic acid (PLA), ethylcellulose (EC), cellulose acetate (CA), cellulose propionate (CP), cellulose acetate/butyrate (CAB), and combinations thereof.

In a more preferred embodiment of the presently claimed invention, the thermoplastic polymer is selected from the group of polyvinyl chloride (PVC), polyvinyl butyral (PVB), ethylene vinyl (EVA), )homopolymers and copolymers of vinyl acetate, homopolymers and copolymers of styrene, polyacrylates, polyurethanes (PU), polysulfides, and combinations thereof.

In a more preferred embodiment of the presently claimed invention, the polyurethane (PU) comprises thermoplastic polyurethane (TPU).

In an even more preferred embodiment of the presently claimed invention, the thermoplastic polymer is selected from the group of polyvinyl chloride (PVC), ethylene vinyl acetate (EVA), polyurethanes (PU), and combinations thereof.

In a most preferred embodiment of the presently claimed invention, the thermoplastic polymer is polyvinyl chloride (PVC).

In a preferred embodiment of the presently claimed invention, the at least one polymer is an elastomer selected from the group natural rubbers, synthetic rubbers, and mixtures thereof. Herein, the synthetic rubbers is selected from the group consisting of polyisoprene rubber (IR), styrene-butadiene rubber (SBR), butadiene rubber (BR), nitrile-butadiene rubber (NBR), and chloroprene rubber (CR). The natural rubber is selected from polyisoprenes that are extracted from latex of plants selected from the group consisting of Havea brasiliensis, Landolphia kiirkii, Landophilia heudelotis, Landophilia owariensis, Ficus elastica, Castilla elastica, and Euphorbia spp. Natural rubber typically have a molecular weight in the range from 100,000 to 1,00,000 Daltons.

In a more preferred embodiment of the presently claimed invention, the at least one polymer is a vulcanized rubber. The vulcanization may be carried out by well-known methods using sulfur.

In a preferred embodiment of the presently claimed invention, the molding compositions comprise elastomer in an amount from 20% to 95 wt.%, preferably is 45% to 90 wt.%, and more particularly 50 to 85 wt.%.

The thermoplastic polymer or thermoplastic polymer mixture is present in the molding composition, different amounts of plasticizer are used. In a preferred embodiment of the presently claimed invention, the plasticizer composition is present in an amount from 1.0 to 300 phr (parts per hundred resin, i.e., parts by weight per hundred parts by weight of polymer), preferably 1.0 to 130 phr, more preferably 1.0 to 100 phr.

In another preferred embodiment of the presently claimed invention, the molding composition comprises at least one thermoplastic polymer other than polyvinyl chloride in an amount from 0.5 to 300 phr, preferably 1.0 to 130 phr, more preferably 1.0 to 100 phr.

In another preferred embodiment of the presently claimed invention, the molding composition further comprises an adjuvant selected from the group consisting of stabilizers, lubricants, filler, pigments, flame retardants, light stabilizers, blowing agents, polymeric processing assistants, impact tougheners, optical brighteners, antistats, biostabilizers, and mixtures thereof.

A number of suitable adjuvants are described in more detail below. The examples given, however, do not impose any restriction on the molding compositions of the invention, but instead serve merely for elucidation. All amount details as described hereinbelow are based on the molding composition as a whole. The values are in terms of phr, based on the base resin (per hundred resin).

Stabilizers of the presently claimed invention include all customary PVC stabilizers in solid and liquid form, examples being customary Ca/Zn, Ba/Zn, Pb or Sn stabilizers, acid-binding phyllosilicates, such as hydrotalcite, and organic stabilizers such as epoxidized soyabean oil.

The molding compositions of the presently claimed invention may have a stabilizer content of 0.05% to 7%, preferably 0.1% to 5%, more preferably of 0.2% to 4%, and more particularly of 0.5% to 3%. The values are in terms of wt.%, based on the molding composition as a whole.

Lubricants reduce the adhesion between the plastics to be processed and metal surfaces and ought to counteract frictional forces during mixing, plastifying, and deforming.

The molding compositions of the presently claimed invention may comprise, as lubricants, all lubricants customary for the processing of plastics. Those contemplated include, for example hydrocarbons, such as oils, paraffins, and PE waxes, fatty alcohols having 6 to 20 carbon atoms, ketones, carboxylic acids, such as fatty acids and montanic acid, oxidized PE wax, metal salts of carboxylic acids, carboxamides, and also carboxylic esters, examples being those with the alcohols ethanol, fatty alcohols, glycerol, ethanediol, pentaerythritol, and long-chain carboxylic acids as acid component.

The molding compositions of the presently claimed invention may have a lubricant content of 0.0% to 10%, preferably 0.01 % to 5%, more preferably of 0.05% to 3%, and more particularly of 0.1% to 2%. The values are in terms of wt.%, based on the molding composition as a whole.

Fillers influence in particular the compressive strength, tensile strength, and flexural strength, and also the hardness and heat distortion resistance, of plasticized PVC in a positive way.

For the purposes of the presently claimed invention, the molding compositions may also comprise fillers, such as, for example, such as natural calcium carbonates, as for example chalk, limestone, and marble, synthetic calcium carbonates, dolomite, silicates, silica and sand. Preferred fillers used are calcium carbonates, chalk, dolomite, kaolin, silicates, talc, or carbon black.

The molding compositions of the presently claimed invention may have a filler content of 5.0 phr to 800 phr, preferably 10 phr to 400 phr, and more preferably of 20 phr to 200 phr.

For the purposes of the presently claimed invention, the molding compositions may also comprise functional additives, such as, for example, such as diatomaceous earth and aluminum silicates such as, kaolin, mica, and feldspar.

The molding compositions of the presently claimed invention may have a functional additive content of 5.0 phr to 800 phr, preferably 10 phr to 400 phr, and more preferably of 20 phr to 200 phr.

The molding compositions of the presently claimed invention may also comprise pigments, in order to adapt the resulting product to different possible applications.

For the purposes of the presently claimed invention, both inorganic pigments and organic pigments may be used. Inorganic pigments used may be, for example, cobalt pigments, such as CoO/Al₂O₃, and chromium pigments, as for example Cr₂O₃. Organic pigments contemplated include, for example, mon-oazo pigments, condensed azo pigments, azomethine pigments, anthraquinone pigments, quinacridones, phthalocyanine pigments and dioxazine pigments.

The molding compositions of the presently claimed invention may have a pigment content of 0.01% to 10%, preferably 0.05% to 5%, more preferably of 0.1% to 3%, and more particularly of 0.5% to 2%. The values are in terms of wt.%, based on the molding composition as a whole.

In order to reduce flammability and to reduce the level of smoke given off on burning, the molding compositions of the invention may also comprise flame retardants and smoke suppressants.

Examples of flame retardants which can be used include antimony trioxide, phosphate esters, chlorinated paraffin, aluminum hydroxide and boron compounds.

Examples of smoke suppressants which can be used include aluminium hydrate and magnesium hydroxide.

The molding compositions of the presently claimed invention may have a flame retardant content of 0.1 phr to 50 phr, preferably 0.5 phr to 40 phr, and more preferably of 1 phr to 5 phr.

In order to protect articles produced from the molding compositions of the presently claimed invention from surface-region damage due to the influence of light, the molding compositions may also comprise light stabilizers, for example, UV absorbers.

For the purposes of the presently claimed invention it is possible to use hydroxybenzophenones, hy-droxyphenylbenzotriazoles, cyanoacrylates or what are known as hindered amine light stabilizers (HALS) such as the derivatives of 2,2,6,6-tetramethylpiperidine and Tinuvin XT 835, for example, as light stabilizers.

The molding compositions of the presently claimed invention may have a light stabilizer content, for example UV absorber, of 0.01% to 7%, preferably 0.1% to 5%, more preferably of 0.2% to 4%, and more particularly of 0.5% to 3%. The values are in terms of wt.%, based on the molding composition as a whole.

In order to reduce density, increase thermal and acoustic insulation in articles, the molding compositions of the presently claimed invention may also comprise blowing agents.

For the purposes of the presently claimed invention it is possible to use isocyanate, azodicarbonamide, hydrazine, for example, as blowing agents.

The molding compositions of the presently claimed invention may have a blowing agent content, of 0.05% to 5%, preferably 0.1% to 4%, more preferably of 0.2% to 3%, and more particularly of 0.5% to 3%. The values are in terms of wt.%, based on the molding composition as a whole.

In order to reduce decomposition temperature of foaming agent, the molding composition of the presently claimed invention may also comprise kicker.

For the purposes of the presently claimed invention it is possible to use zinc oxide, potassium-zinc, barium-zinc, for example, as kicker.

The molding compositions of the presently claimed invention may have a kicker content, of 0.5 phr to 5 phr, preferably 1 phr to 4 phr and more preferably 1 phr to 3 phr.

In order to increase processability and lower melt viscosity, the molding compositions of the presently claimed invention may also comprise polymeric processing assistant.

For the purposes of the presently claimed invention it is possible to use fluoropolymers such as copolymers of vinylidene fluoride and hexafluoropropylene, and also acrylic resin such as Paraloid B-72, for example, as polymeric processing assistant.

The molding compositions of the presently claimed invention may have a polymeric processing assistant content, of 0.2 phr to 15 phr, preferably 0.5 phr to 10 phr, more preferably of 0.8 phr to 5 phr, and more particularly of 1 phr to 7 phr.

In order to increase mechanical robustness, the molding compositions of the presently claimed invention may also comprise impact toughener.

For the purposes of the presently claimed invention it is possible to use rubber nanoparticles such as polybutadiene having a particle size in the range from 10 to 5000 nm, for example, as impact toughener.

The molding compositions of the presently claimed invention may have a polymeric processing assistant content, of 0.01 phr to 50 phr, preferably 1 phr to 40 phr, more preferably of 2 phr to 35 phr, and more particularly of 5 phr to 30 phr. Phr stands for parts by weight per 100 parts by weight of polymer.

In order to improve aesthetic appeal and lighten color of article, the molding compositions of the presently claimed invention may also comprise optical brightener.

For the purposes of the presently claimed invention it is possible to use an optical brightener selected from the group consisting of 2, 5-thiophenediylbis (5-tert-butyl-1, 3-benzoxazole), 2, 2′-(1, 2-eth-enediyldi-4, 1-phenylene) bisbenzoxazole, stilbene bistriazine, 1,4-bis-o-cyanostyryl-benzene, 4,4′-bis(2,4-cyano-phenlene)-benzene, 4,4′-bis[2-(2-methoxyphenyl)ethyl]-1,1′-diphenyl, and 1,4-bis(2-ben-zoxazoly)naphthalene.

The molding compositions of the presently claimed invention may have an optical brightener content, of 0.1 ppm to 400 ppm, preferably 0.5 ppm to 100 ppm, more preferably of 2 ppm to 80 ppm, and more particularly of 5 ppm to 40 ppm. The values are based on the molding composition as a whole.

In order to improve aesthetic appeal and lighten color of article, the molding compositions of the presently claimed invention may also comprise optical brightener.

For the purposes of the presently claimed invention it is possible to use an optical brightener selected from the group consisting of 2, 5-thiophenediylbis (5-tert-butyl-1, 3-benzoxazole), 2, 2′-(1, 2-ethenediyldi-4, 1-phenylene) bisbenzoxazole, stilbene bistriazine, 1,4-bis-o-cyanostyryl-benzene, 4,4′-bis(2,4-cyano-phenlene)-benzene, 4,4′-bis[2-(2-methoxyphenyl)ethyl]-1,1′-diphenyl, and 1,4-bis(2-ben-zoxazoly)naphthalene.

The molding compositions of the presently claimed invention may have an optical brightener content, of 0.1 ppm to 400 ppm, preferably 0.5 ppm to 100 ppm, more preferably of 2 ppm to 80 ppm, and more particularly of 5 ppm to 40 ppm. The values are based on the molding composition as a whole.

In order to reduce or eliminate a static build up in article, the molding compositions of the presently claimed invention may also comprise antistat.

For the purposes of the presently claimed invention it is possible to use a antistat selected from the group consisting of long chain aliphatic amine (optionally ethoxylated), quaternary ammonium salts (e.g., behentrimonium chloride or cocamidopropyl betaine), esters of phosphoric acid, polyethylene glycol esters, long-chain alkyl phenols, ethoxylated amines, glycerol esters such as glycerol monostearate, PEDOT:PSS, and conducting nanofibers such as polyaniline nanofibers.

The molding compositions of the presently claimed invention may have an antistat content, of 0.1 ppm to 10000 ppm, preferably 0.5 ppm to 5000 ppm, more preferably of 2 ppm to 800 ppm, and more particularly of 5 ppm to 100 ppm. The values are based on the molding composition as a whole.

In order to prevent microbial degradation in article, the molding compositions of the presently claimed invention may also comprise biostabilizer.

For the purposes of the presently claimed invention it is possible to use a biostabilizer such as isotha-zoline, 10′, 10′-oxybisphenox arsine, 2-n-octyl-4-isothiazolin-3-one and dichloro-2-n-octyl-4-isothiazolin-3-one, and tributyl tin.

The molding compositions of the presently claimed invention may have a biostabilizer content, of 0.1 ppm to 10000 ppm, preferably 0.5 ppm to 5000 ppm, more preferably of 2 ppm to 800 ppm, and more particularly of 5 ppm to 100 ppm. The values are based on the molding composition as a whole.

### Applications

Yet another aspect of the presently claimed invention, is directed to the use of the at least one compound of formula (I) as described herein or the plasticizer composition as described herein comprising the at least one compound of formula (I) as described herein, as plasticizer for thermoplastic polymers and elastomers.

Another preferred embodiment of the presently claimed invention, is directed to the use of the plasticizer composition as described herein comprising the at least one compound of formula (I) as described herein; and at least one compound of formula (II) as described herein, as plasticizer for thermoplastic polymers and elastomers.

The embodiments in relation to at least one compound of formula (I) as mentioned hereinabove are to be considered relevant.

The embodiments in relation to the plasticizer composition comprising the at least one compound of formula (I) as mentioned hereinabove are to be considered relevant.

The presently claimed invention also includes the use of the at least one compound of formula (I) or plasticizer composition of the presently claimed invention as and/or in auxiliaries selected from: calendaring auxiliaries; rheology auxiliaries; surfactant compositions, such as flow aids and film-forming aids, defoamers, antifoams, wetting agents, coalescing agents, and emulsifiers; lubricants, such as lubricating oils, lubricating greases, and lubricating pastes; quenchers for chemical reactions; phlegmatizing agents; pharmaceutical products; plasticizers in adhesives or sealants; impact modifiers, and standardizing additives.

In a preferred embodiment of the presently claimed invention, the use of the at least one compound of formula (I) as plasticizer is for PVC plastic.

In a preferred embodiment of the presently claimed invention, the use of the at least one compound of formula (I) as plasticizer is for non-PVC plastic selected from the group consisting of polyvinyl butyral (PVB), ethylene vinyl acetate (EVA), homopolymers and copolymers of vinyl acetate, homopolymers and copolymers of styrene, polyacrylates, polyurethanes (PU), polysulfides, natural rubber, styrene butadiene rubber, polyolefins, and polyvinyl alcohol.

In a preferred embodiment of the presently claimed invention, the use of the plasticizer composition as plasticizer is for PVC plastic.

In a preferred embodiment of the presently claimed invention, the use of the plasticizer composition as plasticizer is for non-PVC plastic selected from the group consisting of polyvinyl butyral (PVB), ethylene vinyl acetate (EVA), homopolymers and copolymers of vinyl acetate, homopolymers and copolymers of styrene, polyacrylates, polyurethanes (PU) and polysulfides.

Another aspect of the presently claimed invention is directed to the use of the molding composition for producing moldings and foils.

In a preferred embodiment of the presently claimed invention, the reduced gelation temperature of the molding compositions make it particularly suitable for plastisol application, which would make them particularly suitable for processing by spreading, dipping, pouring, casting, molding, coating, spraying, and printing. Molding may include slush molding.

The embodiments in relation to the molding composition as mentioned hereinabove are to be considered relevant.

In a preferred embodiment of the presently claimed invention, the moldings and foils are employed to produce products selected from the group of self-adhesive films, hygiene products, packaging for food or drink, products for the interior sector, toys and child-care items, sports-and-leisure products, apparel, fibers for textiles, housings of electrical devices, computer housings, tooling, piping, cables, hoses, wire sheathing, window profiles, vehicle-construction components, tires, furniture, cushion foam and mattress foam, tarpaulins, gaskets, composite foils, recording disks, synthetic leather, packaging containers, adhesive-tape foils, and coatings.

The molding composition of the presently claimed invention is preferably used for the production of moldings and foils. Among these are in particular housings of electrical devices, for example of kitchen appliances, and computer housings; tooling; equipment; piping; cables; hoses, for example plastics hoses, water hoses and irrigation hoses, industrial rubber hoses, or chemicals hoses; wire sheathing; window profiles; vehicle-construction components, for example bodywork constituents, vibration dampers for engines; tires; furniture, for example chairs, tables, or shelving; cushion foam and mattress foam; tarpaulins, for example truck tarpaulins, tenting or roof tarpaulins; gaskets; composite foils, such as foils for laminated safety glass, in particular for vehicle windows and/or window panes; recording disks; synthetic leather; packaging containers; adhesive-tape foils, or coatings.

In a preferred embodiment of the presently claimed invention, the moldings and foils come directly into contact with humans or with foods. These are primarily medical products, hygiene products, packaging for food or drink, products for the interior sector, toys and child-care items, sports-and-leisure products, apparel, or fibers for textiles, and the like.

The medical products which can be produced from the molding composition of the presently claimed invention are by way of example tubes for enteral nutrition and hemodialysis, breathing tubes, infusion tubes, infusion bags, blood bags, catheters, tracheal tubes, disposable syringes, gloves, or breathing masks.

The packaging that can be produced from the molding composition of the presently claimed invention for food or drink is by way of example freshness-retention foils, food-or-drink hoses, drinking-water hoses, containers for storing or freezing food or drink, lid gaskets, closure caps, crown corks, or synthetic corks for wine.

The products which can be produced from the molding composition of the presently claimed invention for the interior sector are by way of example ground-coverings, which can be of homogeneous structure or can be composed of a plurality of layers, for example of at least one foamed layer, examples being floorcoverings, sports floors, or luxury vinyl tiles (LVTs), synthetic leathers, floor mats, cove base, wallcoverings, ceiling coverings or foamed or unfoamed wallpapers, in buildings, or can be cladding or console covers in vehicles.

The toys and child-care items which can be produced from the molding composition of the presently claimed invention are by way of example dolls, inflatable toys, such as balls, toy figures, toy animals, anatomic models for training, modeling clays, swimming aids, stroller covers, baby-changing mats, bedwarmers, teething rings, or bottles.

The sports-and-leisure products that can be produced from the molding composition of the presently claimed invention are by way of example gymnastics balls or other balls, exercise mats, seat cushions, massage balls and massage rollers, shoes and shoe soles, air mattresses, or drinking bottles.

The apparel that can be produced from the molding compositions of the presently claimed invention is by way of example (coated) textiles, such as tents and latex clothing, protective apparel or rain apparel, for instance rain jackets, or rubber boots.

The presently claimed invention offers one or more of the following advantages:
1) The compound of formula (I) of the presently claimed invention has a novel cyclohexanol-based end capping.
2) The compound of formula (I) of the presently claimed invention shows a significant lowering in terms of gelation temperature versus commercially known plasticizers. The low gelation temperature is expected to result in the enhancement of processability.
3) The compound of formula (I) of the presently claimed invention shows a significantly lower water solubility.
4) The compound of formula (I) of the presently claimed invention shows a lower viscosity, thus indicating an improved industrial applicability as plasticizer.
5) The compound of formula (I) of the presently claimed invention is environmentally benign and can therefore be used as part moldings that are suitable for human contact and/or use, such as medical products, food packaging and childcare articles, among others.
5) The molding compositions of the presently claimed invention have a high compatibility, particularly with PVC.
6) The molding compositions of the presently claimed invention show enhanced retention within films, foils and moldings, even in the presence of oil or fats or humid conditions or high temperature or UV.
7) The molding compositions of the presently claimed invention show comparable mechanical properties as the compositions comprising commercially available plasticizers. Therefore, the compound of formula (I) does not compromise the properties of the final molding compositions.
8) The molding compositions of the presently claimed show minimal migration of the plasticizer, when combined with multi-layered or composite polymeric materials.

In the following, there is provided a list of embodiments to further illustrate the present disclosure without intending to limit the disclosure to the specific embodiments listed below.
1. A compound of the formula (I),

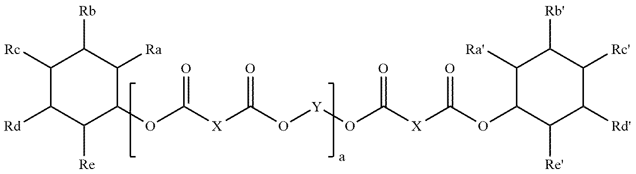

in which
   X independently at each occurrence is selected from the group of unbranched or branched, unsubstituted or substituted C₄-C₈ alkylene, unbranched or branched, unsubstituted or substituted C₂-C₈ alkenylene, unsubstituted or substituted C₆-C₁₅ arylene, and unsubstituted or substituted C₆-C₁₅ cycloalkylene,
   Y independently at each occurrence is selected from the group of unbranched or branched, unsubstituted or substituted C₄-C₁₂ alkylene and unbranched or branched, unsubstituted or substituted C₂-C₁₂ alkenylene,
   a is an integer in the range from 1 to 100, and
   Ra, Rb, Rc, Rd, Re, Ra′, Rb′, Rc′, Rd′, and Re′ independently at each occurrence are selected from the group of H, unbranched or branched, unsubstituted or substituted C₁-C₁₂ alkyl and unbranched or branched, and unsubstituted or substituted C₂-C₁₂ alkenyl.
2. The compound according to embodiment 1, wherein the compound has a number average molecular weight (Mn) in the range from 500 to 15 000 g/mol, determined according to ASTM D3016.
3. The compound according to embodiment 1, wherein a is an integer in the range from 1 to 40.
4. The compound according to any of the embodiments 1 to 3, wherein the compound has a viscosity in the range from 200 to 20000 mPa.s, determined according to ASTM D445.
5. The compound according to any of the embodiments 1 to 4, wherein the compound has a gelation temperature in the range from 110 to 140° C.
6. The compound according to any of the embodiments 1 to 5, wherein X independently at each occurrence is unbranched, unsubstituted C₄-C₆ alkylene and Y independently at each occurrence is unbranched, unsubstituted C₄-C₆ alkylene.
7. The compound according to any of the embodiments 1 to 5, wherein X independently at each occurrence is unbranched, unsubstituted C₄-C₅ alkylene and Y is independently at each occurrence unbranched, unsubstituted C₄-C₅ alkylene.
8. The compound according to any of the embodiments 1 to 5, wherein X independently at each occurrence is unsubstituted C₆-C₁₀ arylene and Y independently at each occurrence is unbranched, unsubstituted C₄-C₅ alkylene.
9. The compound according to any of the embodiments 1 to 5, wherein X independently at each occurrence is unsubstituted C₆-C₈ arylene and Y is independently at each occurrence unbranched, unsubstituted C₄-C₅ alkylene.
10. The compound according to any of the embodiments 1 to 9, wherein Ra, Rb, Rc, Rd, Re, Ra′, Rb′, Rc′, Rd′, and Re′ are H.
11. A plasticizer composition comprising at least one compound of formula (I) according to any of the embodiments 1 to 10.
12. The plasticizer composition according to embodiment 11, comprising at least one compound of the formula (II),

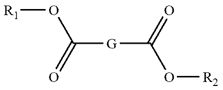

wherein
   R₁ and R₂ independently of one another are unbranched or branched, unsubstituted or substituted C₄-C₁₂ alkyl, and
   G is selected from the group of unbranched or branched, unsubstituted or substituted C₂-C₈ alkylene; unsubstituted or substituted phenylene; and unsubstituted or substituted cylcohexylene.
13. The plasticizer composition according to embodiment 12, wherein R₁ and R₂ are independently selected from the group of 2-ethylhexyl, 2-propylheptyl, n-nonyl, isononyl, n-octyl, n-decyl, and isodecyl.
14. The plasticizer composition according to any of the embodiments 12 or 13, wherein G is selected from unbranched, unsubstituted C₂-C₆ alkylene.
15. The plasticizer composition according to any of the embodiments 12 to 14, wherein G is unsubstituted phenylene.
16. The plasticizer composition according to any of the embodiments 12 or 15, wherein G is unsubstituted cyclohexylene.
17. The plasticizer composition according to any of the embodiments 11 to 16, further comprising a third compound which is different from the compounds (I) and (II) and which is selected from the group of trimellitic trialkyl esters, benzoic alkyl esters, dibenzoic esters of glycols, hydroxybenzoic esters, esters of saturated monocarboxylic acids, esters of unsaturated monocarboxylic acids, amides and esters of aromatic sulfonic acids, alkylsulfonic esters, glycerol esters, isosorbide esters, phosphoric esters, citric triesters, alkylpyrrolidone derivatives, 2,5-furandicarboxylic esters, 2,5-tetrahydrofurandicarboxylic esters, epoxidized vegetable oils, epoxidized fatty acid monoalkyl esters, and polyesters of aliphatic and/or aromatic polycarboxylic acids with at least dihydric alcohols, other than compounds of formula (I).
18. The plasticizer composition according to any of the embodiments 11 to 17, wherein the at least one compound of formula (I) is present in an amount in the range from 10 to 99.5 wt.%, based on the total amount of the plasticizer composition.
19. The plasticizer composition according to any of the embodiments 11 to 18, wherein the at least one compound of the formula (II) is present in an amount in the range from 1 to 90 wt.%, based on the total amount of the plasticizer composition.
20. The plasticizer composition according to any of the embodiments 11 to 19, wherein the weight ratio of the at least one compound of formula (II) to the at least one compound of formula (I) is in the range from 1 : 100 to 10 : 1.
21. A molding composition comprising: i) at least one polymer; and ii) at least one compound of formula (I) according to any of the embodiments 1 to 10 or the plasticizer composition according to any of the embodiments 11 to 20.
22. The molding composition according to embodiment 21, wherein the at least one polymer is a thermoplastic polymer selected from the group of
   homopolymers or copolymers comprising in copolymerized form at least one monomer selected from C₂-C₁₀ monoolefins, 1,3-butadiene, 2-chloro-1,3-butadiene, vinyl alcohol and its C₂-C₁₀ alkyl esters, vinyl chloride, vinylidene chloride, vinylidene fluoride, tetrafluoroethylene, glycidyl acrylate, glycidyl methacrylate, acrylates and methacrylates of C₁-C₁₀ alcohols, vinylaromatics, (meth)acrylonitrile, maleic anhydride, and α-ethylenically unsaturated monocarboxylic and dicarboxylic acids,
   homopolymers and copolymers of vinyl acetals,
   polyvinyl esters,
   polycarbonates,
   polyesters,
   polyethers,
   polyetherketones,
   polyurethanes,
   polysulfides,
   polysulfones,
   polyethersulfones,
   cellulose alkyl esters,
   and mixtures thereof.
23. The molding composition according to embodiment 22, wherein the thermoplastic polymer is selected from the group of polyvinyl chloride (PVC), polyvinyl butyral (PVB), ethylene vinyl acetate (EVA), homopolymers and copolymers of vinyl acetate, homopolymers and copolymers of styrene, polyacrylates, polyurethanes (PU), polysulfides, and combinations thereof.
24. The molding composition according to any of the embodiments 22 and 23, wherein the thermoplastic polymer is polyvinyl chloride (PVC).
25. The molding composition according to any of the embodiments 21 to 24, wherein the plasticizer composition is present in an amount from 1.0 to 300 phr, based on the total amount of the molding composition.
26. The molding composition according to any of the embodiments 21 to 25, wherein the molding composition comprises at least one thermoplastic polymer other than polyvinyl chloride in an amount from 0.5 to 300 phr, based on the total amount of the molding composition.
27. The molding composition according to embodiment 21, wherein the at least one polymer is an elastomer selected from the group natural rubbers, synthetic rubbers, and mixtures thereof.
28. The molding composition according to embodiment 27, wherein the plasticizer composition is present in an amount from 1.0 to 100 phr, based on the total amount of the molding composition.
29. The molding composition according to any of the embodiments 21 to 28, further comprising an adjuvant selected from the group consisting of stabilizers, lubricants, filler, pigments, flame retardants, light stabilizers, blowing agents, polymeric processing assistants, impact tougheners, optical brighteners, antistats, biostabilizers, and mixtures thereof.
30. Use of the compound of formula (I) according to any of the embodiments 1 to 10 or the plasticizer composition according to any of the embodiments 11 to 20, as plasticizer for thermoplastic polymers and elastomers.
31. Use of the molding composition according to any of the embodiments 21 to 29 for producing moldings and foils.
32. The use according to claim 31, wherein the moldings and foils are employed to produce products selected from the group of self-adhesive films, hygiene products, packaging for food or drink, products for the interior sector, toys and child-care items, sports-and-leisure products, apparel, fibers for textiles, housings of electrical devices, computer housings, tooling, piping, cables, hoses, wire sheathing, window profiles, vehicle-construction components, tires, furniture, cushion foam and mattress foam, tarpaulins, gaskets, composite foils, recording disks, synthetic leather, packaging containers, adhesive-tape foils, and coatings.
33. The use according to any of the embodiments 31 or 32, wherein the moldings and foils come directly into contact with humans or with foods.
34. Use according to claims 31 to 33, wherein the molding composition is processed by a method selected from the group consisting of spreading, dipping, pouring, casting, molding, coating, spraying, printing, and combinations thereof.

While the presently claimed invention has been described in terms of its specific embodiments, certain modifications and equivalents will be apparent to those skilled in the art and are intended to be included within the scope of the presently claimed invention.

The examples and the figures described below provide further explanation of the invention. These examples and figures are not to be understood as restricting the invention.

### Examples

The presently claimed invention is illustrated in detail by non-restrictive working examples which follow. More particularly, the test methods specified hereinafter are part of the general disclosure of the application and are not restricted to the specific working examples.

### Materials

Ingredients used in the examples are listed in the Table 1 below:

TABLE 1

| | |
|---|---|
| Ingredient | Manufacturer |
| Suspension-polyvinylchloride, Trade name OxyVinyls® 226F Abbreviation: PVC) | Oxyvinyls, Texas, USA |
| Comparative polyester plasticizer based on hexandioic acid, 2,2-dimethyl-1,3-propanediol, 1,2-propanediol, and i-nonanol, Trade name Palamoll® 652 (abbreviation: Pal 1) | BASF Corp., Cormwall, Canada |
| Comparative polyester based on hexandioic acid, 2,2-dimethyl-1,3-propanediol, 1,4-butanediol, and i-nonanol, Trade name Palamoll® 654 (abbreviation: Pal 2) | BASF Corp., Cormwall, Canada |
| Comparative polyester based on hexandioic acid, 2,2-dimethyl-1,3-propanediol, 1,4-butanediol, and i-nonanol, Trade name Palamoll® 656 (abbreviation: Pal 3) | BASF Corp., Cormwall, Canada |
| Cyclohexanol, (abbreviation: CyOH) | Univar, USA |
| Esterification catalyst- Isopropyl butyl titanate Tradename: Tyzor TPT-20B | Dorf-Ketal, USA |
| Ca-Zn Stabilizer Trade name Baerlocher B1760, (abbreviation: Stabilizer) | Baerlocher, USA |

### Preparation of Plasticizer Compound

The inventive compounds of formula I (labelled as CyOH-1, CyOH-2 and CyOH-3) were formulated proportionate to the plasticizers, i.e., Pal 1, Pal 2 and Pal 3 (refer Table 2 below).

TABLE 2

| Compound (in kg) | Example 1 CyOH-1 | Comparative 1 Pal 1 | Example 2 CyOH-2 | Comparative 2 Pal 2 | Example 3 CyOH-3 | Comparative 3 Pal 3 |
|---|---|---|---|---|---|---|
| Hexandioic acid | 13000 | 13000 | 13000 | 13000 | 13000 | 13000 |
| i-nonanol | 0 | 4847 | 0 | 3320 | 0 | 2413 |
| Cyclohexanol | 3371 | 0 | 2309 | 0 | 1678 | 0 |
| 1,4-Butanediol | 0 | 0 | 4485 | 4485 | 4528 | 4528 |
| 2,2-dimethyl-1,3-propanediol | 6452 | 6452 | 3839 | 3839 | 3878 | 3878 |
| 1,2-propanediol | 1818 | 1818 | 0 | 0 | 0 | 0 |
| Isopropyl butyl titanate | 1 | 1 | 1 | 1 | 1 | 1 |

The compound of formula (I) were prepared by esterification of suitable diols (fragment Y of Formula I) with dioic acid (fragment X of Formula I). The various compounds evaluated are listed in the Table 3 below.

A representative process is as follows: Adipic acid, cyclohexanol, and diols were combined in a 2 L cylindrical reaction vessel fitted with a nitrogen sparge tube, thermocouple, mechanical stir rod, and a column topped with a Dean Stark apparatus with reflux condenser. The reaction was stirred under nitrogen and the temperature was set to 230° C. The titanate catalyst was added at a reaction temperature of 176° C. The reaction was put under vacuum (180 torr) once the reaction temperature reached 230° C. The heat and vacuum were turned off after water generation stopped and the reaction mixture recorded an acid number < 2 mg KOH/g. The reaction mixture was filtered through a layer of Fuller’s Earth to obtain the compound of formula (I).

### Characterization of Plasticizer Compounds

The compounds listed above in Table 2 (Examples 1-3 and Comparative 1-3) were characterized based on below mentioned methods-

Viscosity: The viscosity was determined by analogy to ASTM D445, using a Thermo-Haake® Ro-toVisco® 1 rotational rheometer equipment under the CR mode at 25° C. at rotational speed of 180 U/min equivalent to 1 Ncm shear rate (setting 1). A low viscosity is considered advantageous in terms of processability of the molding composition, as described herein.

Molecular weight: Number average molecular weight measured on a Waters Alliance HPLC System. Number average molecular weight (Mn) defined according to ASTM D3016.

Volatility: The volatility of plasticizers should advantageously be low, in order to resist removal upon exposure to high temperature conditions. The PVC-based molding compositions as mentioned below were tested using a method adapted from ASTM D2103.

Acid number: The acid number is a measure of this amount of acidic substance in the oil, always under the conditions of the test. The acid number is used as a guide in identifying degree of completion of esterification. The method used to measure same was adapted from ASTM D664.

Color number: Color number is measured after ASTM D-5386, results in Pt—Co units (APHA). The color number indicated the time needed for the reaction, the longer the higher the color number. Higher molecular weight compounds usually need longer and therefore have higher color. The color number of lab made products is usually higher than the color number of products out of production reactors.

Gelation: The gelation temperature was measured using a DHR parallel plate rheometer with a temperature ramp of 50-200° C. at a 3° C./min rate. The gelation temperature is reported as the temperature at maximum torque.

TABLE 3

| Compound | Example 1 CyOH-1 | Comparative 1 Pal 1 | Example 2 CyOH-2 | Comparative 2 Pal 2 | Example 3 CyOH-3 | Comparative 3 Pal 3 |
|---|---|---|---|---|---|---|
| Viscosity (at 25° C.) | 735 | 1380 | 1031 | 3012 | 2438 | 8710 |
| Melting point (°C) | 2820 | 3353 | 3585 | 5468 | 6113 | 7502 |
| Molecular weight (Mn) | 2207 | 2071 | 3530 | 3134 | 4451 | 4152 |
| Gelation (°C) | 127 | 134 | 128 | 134 | 131 | 139 |
| Volatility (at 110° C.) | 0.8 | 0.6 | 1.1 | 0.7 | 0.5 | 0.5 |
| Volatility (at 130° C.) | 1.3 | 0.9 | 1.3 | 1.1 | 0.6 | 0.8 |
| Volatility (at 150° C.) | 2.4 | 1.4 | 1.9 | 1.4 | 0.9 | 1.0 |
| Acid number | 0.34 | 0.75 | 0.026 | 0.6 | 0.043 | 0.6 |
| Solubility in Water | 0.057 | 0.09 | 0.026 | 0.08 | 0.043 | 0.01 |
| Color | 75 | 54 | 162 | 170 | 300 | 300 |

The compounds of Formula I were found to have attributes such as molecular weight and volatility, comparable to the corresponding commercial plasticizers (refer Table 3 above). Viscosity of the inventive plasticizers was found to be beneficially lower than the corresponding commercial plasticizers. Furthermore, the color number values were found to indicate a lower reaction period for the inventive plasticizers, thus highlighting a potential reduction in cost of production. Additionally, it was noteworthy that the gelation temperature of the inventive plasticizers (containing cyclohexanol end-capping) was found to be lower than the commercial plasticizers comprising i-nonanol end-capping. A reduced gelation temperature is considered beneficial in terms of processability. Also, the inventive plasticizer was found to have much lower solubility in water, thus reducing the possibility of leaching from molding compositions.

### Preparation of Molding Composition

Molding composition comprising thermoplastic polymer (PVC) were formulated incorporating varying concentrations of the plasticizer compounds as described under Table 1 above (Examples 1-3). Concentrations of 40, 50 and 70 phr with respect to the PVC (refer Table 4 below).

TABLE 4

| Compositions* | Example 4a 1-40 | Example 4b 1-50 | Example 4c 1-70 | Example 5a 2-40 | Example 5b 2-50 | Example 5c 2-70 | Example 6a 3-40 | Example 6b 3-50 | Example 6c 3-70 |
|---|---|---|---|---|---|---|---|---|---|
| PVC | 100 | 100 | 100 | 100 | 100 | 100 | 100 | 100 | 100 |
| CyOH—1 | 40 | 50 | 70 | 0 | 0 | 0 | 0 | 0 | 0 |
| CyOH—2 | 0 | 0 | 0 | 40 | 50 | 70 | 0 | 0 | 0 |
| CyOH—3 | 0 | 0 | 0 | 0 | 0 | 0 | 40 | 50 | 70 |
| Stabilizer | 3 | 3 | 3 | 3 | 3 | 3 | 3 | 3 | 3 |

*concentrations in phr. Phr stands for parts by weight per 100 parts by weight of polymer, i.e. PVC.

A representative process is as follows:
All ingredients of the composition were preheated to 100° C. in an oven, weighted into a mixing bowl and mixed by a bowels mixer for 15 minutes at 100 ‘C. Then the composition was placed onto the gap of an electrically heated laboratory 2 roll mill (LabTech LMR-SCR-150) The formulation was milled for 5 minutes. Following conditions were used-
40 phr composition subjected to 335 F front roll / 340 F back roll - at 19 rpm front roll and 21 rpm back roll.
50 phr composition subjected to 330 F front roll / 335 F back roll - at 19 rpm front roll and 21 rpm back roll
70 phr composition subjected to 320 F front roll / 325 F back roll - at 19 rpm front roll and 21 rpm back roll

The milled sheet is pulled from the roll in a thickness of ~ 1 mm. After cooling the milled sheet is pressed at a temperature of 350 F under a pressure of xx in a press of type “Wabash press xxx” in press plates to the required thickness.

A similar process was followed by replacing the inventive plasticizer compounds with comparative plasticizer compounds (Comparative 4-Pal 1, Comparative 5-Pal 2 and Comparative 6-Pal 3).

### Testing of Molding Composition

The molding compositions listed above in Table 4 (Examples 4-6) along with Comparative 4-6 were characterized based on below mentioned methods-

Compatibility: The test is used to quantify the compatibility of plasticizers in flexible PVC mold compositions. The method was same as adapted from ASTM D2383.

Hardness measurement: The test was carried out on PVC-based molding compositions in order to establish the hardness of the films. The test was used to establish whether the inventive plasticizers had any adverse effect on the general properties of plastics. Both Shore hardness A and Shore hardness D for soft and hard plastic were measured. The measurement was carried out based on ASTM D2240.

Brittleness: Films of the PVC-based molding composition were tested based on ASTM D746. The test was used to establish whether the inventive plasticizers had any adverse effect on the general properties of plastics.

Torsional stiffness: The rigidity of PVC molding films in terms of the torsional stiffness was established based on ASTM D1043. The test was also used to establish whether the inventive plasticizers had any adverse effect on the general properties of plastics.

Mechanical strength: The strength of PVC molding films in terms of the tensile strength, elongation and elasticity, was established based on ASTM D638. The test was also used to establish whether the inventive plasticizers had any adverse effect on the general properties of plastics.

Solubility/Extraction: the solubility in water and oil were established by SPI-VD-T 12 and SPI-VD-T 13. Herein, the detrimental leaching of plasticizer compounds from the films in presence of water was established.

Migration: The measurement was carried out to establish the tendency of plasticizer to migrate from molding composition into other polymers, when such polymers are combined with molding composition as part of composite or multi-layer laminates. The measurements were carried out by method DIN EN ISO 177.

### Comparison of Molding Comprising CyOH-1 (Example 4) Versus Comparative 4

The molding films comprising CyOH-1 (refer Example 4a-c above) were tested and compared with the films comprising Pal 1 commercial plasticizer (Comparative 4a-c). The results are enlisted below in Table 5.

TABLE 5

| Property | Example 4a CyOH 1 40 phr | Comparative 4a Pal 1 40 phr | Example 4b CyOH 1 50 phr | Comparative 4b Pal 1 50 phr | Example 4c CyOH 1 70 phr | Comparative 4c Pal 1 70 phr |
|---|---|---|---|---|---|---|
| Durometer Shore A Hardness, 15 s | 92.8 | 92.1 | 86.6 | 84.0 | 68.2 | 70.8 |
| Durometer Shore D Hardness, 15 s | 47.8 | 47.8 | 33.4 | 33.2 | 20.2 | 20.6 |
| Brittleness, Tb, °C | 11 | 2 | 2.4 | -9 | -8.4 | -21 |
| Torsional Stiffness, Tf, °C | 14 | 5 | 7 | -6 | -7 | -17 |
| Tensile Strength, psi | 3095 | 3320 | 2786 | 3030 | 2154 | 2250 |
| Ultimate Elongation, % | 298 | 274 | 359 | 339 | 406 | 412 |
| 100% Modulus, psi | 2636 | 2810 | 1922 | 2080 | 988 | 1020 |
| Volatility, (24 hrs at 100° C.), in terms of wt.% loss | 0.9 | 0.8 | 1.1 | 0.8 | 1.5 | 0.9 |
| Volatility, (24 hrs at 130° C., in terms of wt.% loss | 1.4 | 2.2 | 1.7 | 2.4 | 2.2 | 2.8 |
| Compatibility (1 week under humid conditions), in terms of wt.% loss | 0.71 | 0.65 | 0.60 | 0.60 | 0.64 | 0.52 |
| 2 weeks | 0.78 | 0.72 | 0.71 | 0.72 | 0.73 | 0.64 |
| 3 weeks | 0.82 | 0.80 | 0.72 | 0.79 | 0.81 | 0.72 |
| 4 weeks | 0.87 | 0.85 | 0.8 | 0.84 | 0.83 | 0.79 |

*volatility and compatibility measured from 20 mil films

Overall, the results enlisted in Table 5 above, indicate comparable performance of inventive molding composition (Example 4a-c) versus the molding composition comprising Pal 1 (Comparative 4a-c). The physical parameters in terms of hardness and tensile strength was found to be similar to the comparative molding composition. Further, the loss in plasticizer content from films, in terms of volatility, as a well as compatibility loss values were found to improve upon use of inventive plasticizers. Specifically, improvement was found to be established even at low concentrations. The inventive molding composition comprising 40 phr of inventive plasticizer compound of formula (I) (Example 4a) was found to have a minimal volatility loss (at 130° C.) of about 1.4 wt.% in comparison to the 2.2% weight loss observed for the comparative film.

### Comparison of Molding Comprising CyOH-2 (Example 5) Versus Comparative 5

The molding films comprising CyOH-2 (refer Example 5a-c above) were tested and compared with the films comprising Pal 2 commercial plasticizer (Comparative 5a-c). The results are enlisted below in Table 6.

TABLE 6

| Property | Example 5a CyOH 2 40 phr | Comparative 5a Pal 2 40 phr | Example 5b CyOH 2 50 phr | Comparative 5b Pal 2 50 phr | Example 5c CyOH 2 70 phr | Comparative 5c Pal 2 70 phr |
|---|---|---|---|---|---|---|
| Durometer Shore A Hardness, 15 s | 92.2 | 89.5 | 82.8 | 84.2 | 65.2 | 70.2 |
| Durometer Shore D Hardness, 15 s | 45 | 45.8 | 32 | 34.4 | 18.2 | 20.0 |
| Brittleness, Tb, °C | 3 | -2 | -5.8 | -10 | -17.6 | -22 |
| Torsional Stiffness, Tf, °C | 9 | 4 | 2 | -5 | -12 | -17 |
| Tensile Strength, psi | 3089 | 3160 | 2798 | 2890 | 2052 | 2210 |
| Ultimate Elongation, % | 201 | 311 | 355 | 352 | 454 | 408 |
| 100% Modulus, psi | 2818 | 2650 | 1888 | 1930 | 792 | 970 |
| Volatility, (24 hrs at 100° C.), in terms of wt.% loss | 0.6 | 0.4 | 0.7 | 0.5 | 0.9 | 0.5 |
| Volatility, (24 hrs at 130° C., in terms of wt.% loss | 1 | 1.2 | 1.2 | 1.3 | 1.4 | 1.5 |
| Compatibility (1 week under humid conditions), in terms of wt.% loss | 0.67 | 0.48 | 0.65 | 0.60 | 0.69 | 0.56 |
| 2 weeks | 0.67 | 0.70 | 0.74 | 0.63 | 0.7 | 0.66 |
| 3 weeks | 0.72 | 0.70 | 0.74 | 0.68 | 0.78 | 0.72 |
| 4 weeks | 0.79 | 0.74 | 0.75 | 0.76 | 0.8 | 0.78 |

*volatility and compatibility measured from 20 mil films

Overall, the results enlisted in Table 6 above, indicate comparable performance of inventive molding composition (Example 5a-c) versus the composition comprising Pal 2 (Comparative 5a-c). The results were found to be similar to those enlisted in Table 5 above. The physical parameters in terms of hardness and tensile strength was found to be similar to the comparative molding composition. The inventive molding composition comprising 40 phr inventive plasticizer compound of formula (I) (Example 5a) was found to have a minimal volatility loss (at 130° C.) of about 1.0 wt.% in comparison to the 1.2% weight loss observed for the comparative film (Comparative 5a).

### Comparison of Molding Comprising CyOH-3 (Example 6) Versus Comparative 6

The molding films comprising CyOH-3 (refer Example 6a-c above) were tested and compared with the films comprising Pal 3 commercial plasticizer (Comparative 6a-c). The results are enlisted below in Table 7.

TABLE 7

| Property | Example 6a CyOH 3 40 phr | Comparative 6a Pal 3 40phr | Example 6b CyOH 3 50 phr | Comparative 6b Pal 3 50 phr | Example 6c CyOH 3 70 phr | Comparative 6c Pal 3 70 phr |
|---|---|---|---|---|---|---|
| Durometer Shore A Hardness, 15 s | 91.8 | 96.0 | 85.6 | 85.4 | 68.8 | 70.4 |
| Durometer Shore D Hardness, 15 s | 44.8 | 52.4 | 33.4 | 35.6 | 20.2 | 20.9 |
| Brittleness, Tb, °C | -1 | 0 | -8.2 | -10 | -19.2 | -25 |
| Torsional Stiffness, Tf, °C | 11 | 8 | 2 | -4 | -10 | -16 |
| Tensile Strength, psi | 3214 | 3290 | 2764 | 2930 | 2390 | 2450 |
| Ultimate Elongation, % | 289 | 265 | 377 | 330 | 476 | 431 |
| 100% Modulus, psi | 2863 | 2970 | 1901 | 2130 | 1011 | 1110 |
| Volatility, (24 hrs at 100° C.), in terms of wt.% loss | 0.4 | 0.3 | 0.5 | 0.4 | 0.5 | 0.4 |
| Volatility, (24 hrs at 130° C., in terms of wt.% loss | 0.7 | 0.7 | 0.7 | 0.9 | 0.8 | 0.9 |
| Compatibility (1 week under humid conditions), in terms of wt.% loss | 0.52 | 0.54 | 0.63 | 0.52 | 0.58 | 0.46 |
| 2 weeks | 0.56 | 0.66 | 0.69 | 0.61 | 0.62 | 0.50 |
| 3 weeks | 0.6 | 0.73 | 0.71 | 0.71 | 0.66 | 0.60 |
| 4 weeks | 0.64 | 0.80 | 0.71 | 0.76 | 0.67 | 0.61 |

*volatility and compatibility measured from 20 mil films

Overall, the results enlisted in Table 7 above, indicate comparable performance of inventive molding composition (Examples 6a-c) versus the composition comprising Pal 3 (Comparative 6a-c). The results were found to be similar to those enlisted in Tables 5 and 6 above. The physical parameters in terms of hardness and tensile strength was found to be similar to the comparative molding composition. The inventive molding composition comprising 50 phr inventive plasticizer compound of formula (I) (Example 6b) was found to have a minimal volatility loss (at 130° C.) of about 0.7 wt.% in comparison to the 0.9% weight loss observed for the comparative film (Comparative 6b).

### Migration of Plasticizer

Furthermore, the molding compositions may be combined with suitable co-polymers (composites, multi-layered laminates etc). Herein, tests were carried out to establish loss in plasticizer content by migration into co-polymers. All molding composition herein comprised 70 phr of the plasticizer and the tests were carried out at 50° C. The results are enlisted in Table 8 below in terms of weight loss (mass change of the soft PVC in mg) when the molding composition comprising CyOH 1 (Examples 4c) was combined with well-known co-polymers, namely, acrylonitrile butadiene styrene (ABS), acrylonitrile styrene acrylate (ASA), poly(methyl methacrylate) (PMMA), polycarbonate (PC), polystyrene (PS), polyvinyl chloride (PVC), styrene-acrylonitrile (SAN) and styrene-butadiene (SB).

TABLE 8

| Composition | Measurement day | ABS | ASA | PMMA | PC | PS | PVC | SAN | SB |
|---|---|---|---|---|---|---|---|---|---|
| Comparative 4c Pal 1-70 phr | 1^{st} day | -0.7 | -0.6 | -0.2 | -0.1 | -0.9 | -1.8 | 0.7 | -0.6 |
| | 3^{rd} day | -1.5 | -0.4 | -0.4 | -1.3 | -1.2 | -3.2 | 0.3 | -0.6 |
| | 7^{th} day | -1.6 | -1.4 | -0.7 | -1.0 | -1.3 | -5.3 | -1.3 | -0.6 |
| | 14^{th} day | -1.0 | -1.1 | -0.5 | -0.2 | -1.5 | -8.1 | -1.5 | -1.4 |
| | 21^{st} day | -1.1 | -1.6 | -1.0 | -0.6 | -1.5 | -9.6 | -0.6 | -1.2 |
| | 30^{th} day | 0.2 | -0.7 | -0.8 | 0.3 | 0.2 | -10.4 | -0.4 | -0.5 |
| Example 4c CyOH 1-70 phr | 1^{st} day | -0.8 | -0.1 | 0.4 | -1.2 | -1.1 | -0.2 | -0.4 | -0.3 |
| | 3^{rd} day | -0.7 | -0.7 | -0.5 | -0.9 | -1.8 | -2.8 | -1.9 | -0.7 |
| | 7^{th} day | -1.9 | -1.1 | -1.1 | -0.9 | -1.4 | -3.5 | -1.8 | -1.3 |
| | 14^{th} day | -1.6 | -1.0 | -1.0 | -1.1 | -1.6 | -5.3 | -2.8 | -1.5 |
| | 21^{st} day | -1.7 | -1.6 | -1.0 | -0.9 | -0.5 | -5.8 | -2.8 | -1.1 |
| | 30^{th} day | -0.2 | -0.6 | -0.1 | -0.1 | 0.3 | -6.1 | -1.8 | -0.1 |

* values- mg mass change

The higher negative value in Table 8 above indicates a greater weight loss due to migration, therefore, as can be seen, the inventive molding composition is highly resistant towards migration. Further, the resistance to migration for the inventive Example 4c was seen to be uniformly higher than comparative composition (Comparative 4c), irrespective of co-polymer tested. For instance, the comparative molding composition comprising 70 phr of Pal 1 (Comparative 4c), when contacted with PMMA was found to result in a mass change of 0.8% after 30 days of contact. On the other hand, the corresponding inventive molding (Example 4c) was noted to show a minimal loss of only 0.1%. Even when PVC was contacted with the molding compositions, the inventive molding composition (Example 4a) was found to show higher resistance towards migration.

Similar analysis was carried out with molding composition comprising CyOH 2 (Example 5c) and CyOH 3 (Example 6c) in comparison to, comparative example 5c and 6c, and the results were found to be similar, wherein the inventive compositions, were found to show a higher resistance towards migration than the comparative examples. Furthermore, the Table 9 enlists the migration analysis of two well-known plasticizers, i.e., acetyltributylcitrate or ATBC (comparative example 7) and alkylsulphonic acid ester with phenol or ASE (comparative example 8) at 70 phr after 30 days of contact.

TABLE 9

| Composition | ABS | ASA | PMMA | PC | PS | PVC | SAN | SB |
|---|---|---|---|---|---|---|---|---|
| Comparative 8 (70 phr of ATBC) | 21 | 73 | 33 | 71 | 239 | 145 | 139 | 257 |
| Comparative 9 (70 phr of ASE) | 31 | 65 | | 27 | 81 | 99 | 122 | 96 |

As can be seen from the comparison of the results mentioned in Table 9 above, the inventive examples 4c-6c are noted to reveal a high degree of resistance towards migration, especially when in contact with polymers such as PVC. This may be considered as a significant advantage when employing the plasticizer for multi-layered plastic laminate-based applications.

Overall, the compound of formula (I) comprising cyclohexanol-based end capping was found to be an effective plasticizer with low viscosity and gelation temperature. Further, the molding compositions comprising said inventive compounds, were found to have improved properties such as enhanced resistance towards migration and decreased volatility. The performance was found to be particularly impressive, since the inventive compositions were found to outperform comparative compositions comprising similar concentrations of commercially available plasticizer (comprising i-nonanol end capping).

1-31. (canceled)

32. A compound of the formula (I), 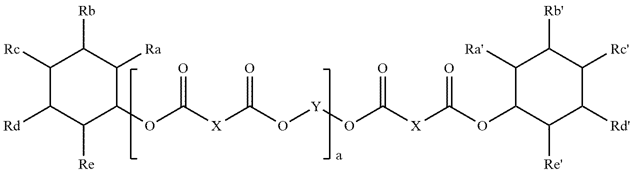
in which
X independently at each occurrence is selected from the group of unbranched or branched, unsubstituted or substituted C₄-C₈ alkylene, unbranched or branched, unsubstituted or substituted C₂-C₈ alkenylene, unsubstituted or substituted C₆-C₁₅ arylene, and unsubstituted or substituted C₆-C₁₅ cycloalkylene,
Y independently at each occurrence is selected from the group of unbranched or branched, unsubstituted or substituted C₄-C₁₂ alkylene and unbranched or branched, unsubstituted or substituted C₂-C₁₂ alkenylene,
a is an integer in the range from 1 to 100, and
Ra, Rb, Rc, Rd, Re, Ra′, Rb′, Rc′, Rd′, and Re′ independently at each occurrence are selected from the group of H, unbranched or branched, unsubstituted or substituted Ci-C₁₂ alkyl and unbranched or branched, unsubstituted or substituted C₂-C₁₂ alkenyl.

33. The compound according to claim 32, wherein the compound has a number average molecular weight (Mn) in the range from 500 to 15 000 g/mol, determined according to ASTM D3016.

34. The compound according to claim 32, wherein a is an integer in the range from 1 to 40.

35. The compound according to claim 32, wherein the compound has a viscosity in the range from 200 to 20000 mPa.s, determined according to ASTM D445.

36. The compound according to claim 32, wherein the compound has a gelation temperature in the range from 110 to 140° C.

37. The compound according to claim 32, wherein X independently at each occurrence is unbranched, unsubstituted C₄-C₆ alkylene and Y independently at each occurrence is unbranched, unsubstituted C₄-C₆ alkylene.

38. The compound according to claim 32, wherein X independently at each occurrence is unsubstituted C₆-Cₗ₀ arylene and Y independently at each occurrence is unbranched, unsubstituted C₄-C₅ alkylene.

39. The compound according to claim 32, wherein Ra, Rb, Rc, Rd, Re, Ra′, Rb′, Rc′, Rd′, and Re′ are H.

40. A plasticizer composition comprising at least one compound of formula (I) according to claim 32.

41. The plasticizer composition according to the claim 40, comprising at least one compound of the formula (II), 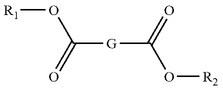
wherein
R₁ and R₂ independently of one another are unbranched or branched, unsubstituted or substituted C₄-C₁₂ alkyl, and
G is selected from the group of unbranched or branched, unsubstituted or substituted C₂-C₈ alkylene; unsubstituted or substituted phenylene; and unsubstituted or substituted cyclohexylene.

42. The plasticizer composition according to claim 41, wherein R₁ and R₂ are independently selected from the group consisting of 2-ethylhexyl, 2-propylheptyl, n-nonyl, isononyl, n-octyl, n-decyl, and isodecyl.

43. The plasticizer composition according to claim 41, wherein G is selected from unbranched, unsubstituted C₂-C₆ alkylene.

44. The plasticizer composition according to claim 41, wherein G is unsubstituted phenylene.

45. The plasticizer composition according to claim 41, wherein G is unsubstituted cyclohexylene.

46. The plasticizer composition according to claim 40, further comprising a third compound which is different from the compounds (I) and (II) and which is selected from the group of trimellitic trialkyl esters, benzoic alkyl esters, dibenzoic esters of glycols, hydroxybenzoic esters, esters of saturated monocarboxylic acids, esters of unsaturated monocarboxylic acids, amides and esters of aromatic sulfonic acids, alkylsulfonic esters, glycerol esters, isosorbide esters, phosphoric esters, citric triesters, alkylpyrrolidone derivatives, 2,5-furandicarboxylic esters, 2,5-tetrahydrofurandicarboxylic esters, epoxidized vegetable oils, epoxidized fatty acid monoalkyl esters, and polyesters of aliphatic and/or aromatic polycarboxylic acids with at least dihydric alcohols, other than compounds of formula (I).

47. The plasticizer composition according to claim 40, wherein the at least one compound of formula (I) is present in an amount in the range from 10 to 99.5 wt.%, based on the total amount of the plasticizer composition.

48. The plasticizer composition according to claim 40, wherein the at least one compound of the formula (II) is present in an amount in the range from 1 to 90 wt.%, based on the total amount of the plasticizer composition.

49. The plasticizer composition according to claim 40, wherein the weight ratio of the at least one compound of formula (II) to the at least one compound of formula (I) is in the range from 1 : 100 to 10 : 1.

50. A molding composition comprising: i) at least one polymer; and ii) at least one compound of formula (I) according to claim 32.

51. The molding composition according to claim 40, wherein the polymer is a thermoplastic polymer selected from the group of
homopolymers or copolymers comprising in copolymerized form at least one monomer selected from C₂-C₁₀ monoolefins, 1,3-butadiene, 2-chloro-1,3-butadiene, vinyl alcohol and its C₂-C₁₀ alkyl esters, vinyl chloride, vinylidene chloride, vinylidene fluoride, tetrafluoroethylene, glycidyl acrylate, glycidyl methacrylate, acrylates and methacrylates of C₁-C₁₀ alcohols, vinylaromatics, (meth)acrylonitrile, maleic anhydride, and α-ethylenically unsaturated monocarboxylic and dicarboxylic acids,
homopolymers and copolymers of vinyl acetals,
polyvinyl esters,
polycarbonates,
polyesters,
polyethers,
polyetherketones,
polyurethanes,
polysulfides,
polysulfones,
polyethersulfones,
cellulose alkyl esters,
and mixtures thereof.

52. The molding composition according to claim 51, wherein the thermoplastic polymer is selected from the group of polyvinyl chloride (PVC), polyvinyl butyral (PVB), ethylene vinyl (EVA), homopolymers and copolymers of vinyl acetate, homopolymers and copolymers of styrene, polyacrylates, polyurethanes (PU), polysulfides, and combinations thereof.

53. The molding composition according to claim 51, wherein the thermoplastic polymer is polyvinyl chloride (PVC).

54. The molding composition according to claim 50, wherein the plasticizer composition is present in an amount from 1.0 to 300 phr, based on the total amount of the molding composition.

55. The molding composition according to claim 50, wherein the molding composition comprises at least one thermoplastic polymer other than polyvinyl chloride in an amount from 0.5 to 300 phr.

56. The molding composition according to claim 50, wherein the at last one polymer is an elastomer selected from the group natural rubbers, synthetic rubbers, and mixtures thereof.

57. The molding composition according to claim 56, wherein the plasticizer composition is present in an amount from 1.0 to 100 phr.

58. The molding composition according to claim 50, further comprising an adjuvant selected from the group consisting of stabilizers, lubricants, filler, pigments, flame retardants, light stabilizers, blowing agents, polymeric processing assistants, impact tougheners, optical brighteners, antistats, biostabilizers, and mixtures thereof.

59. Use of the compound of formula (I) according to claim 32, as plasticizer for thermoplastic polymers and elastomers.

60. Use of the molding composition according to claim 50 for producing moldings and foils.

61. The use according to claim 60, wherein the moldings and foils are employed to produce products selected from the group of self-adhesive films, hygiene products, packaging for food or drink, products for the interior sector, toys and child-care items, sports-and-leisure products, apparel, fibers for textiles, housings of electrical devices, computer housings, tooling, piping, cables, hoses, wire sheathing, window profiles, vehicle-construction components, tires, furniture, cushion foam and mattress foam, tarpaulins, gaskets, composite foils, recording disks, synthetic leather, packaging containers, adhesive-tape foils, and coatings.

62. The use according to claim 60, wherein the moldings and foils come directly into contact with humans or with foods.
